(19) United States
(12) Patent Application Publication
(10) Pub. No.: US 2007/0281775 A1
(43) Pub. Date: Dec. 6, 2007

(54) Gaming Machine System, Game Machine, And Management Server

(76) Inventor: Hiroaki Kashima, Tokyo (JP)

Correspondence Address: ARENT FOX LLP, 1050 CONNECTICUT AVENUE, N.W., SUITE 400, WASHINGTON, DC, 20036, US

(21) Appl. No.: 10/584,498

(22) PCT Filed: Dec. 21, 2004
(86) PCT No.: PCT/JP04/19111

§ 371 Date: May 31, 2007

(30) Foreign Application Priority Data
Dec. 24, 2003 (JP) 2003-426261

(51) Int. Cl. G06F 17/00

(52) U.S. Cl. 463/20

(57) ABSTRACT

A gaming system 100 comprises multiple gaming machines and a management server. Each of the multiple gaming machines includes special game information transmitting device for transmitting bonus game start information to the management server, and special game participation information transmitting device for transmitting bonus game participation information to the management server. The management server includes special game initiation information receiving device for receiving the special game information transmitted from the special game information transmitting device, special game initiation information transmitting device for transmitting a bonus game start notice command to the gaming machines other than the gaming machine that has transmitted the special game information, and game value providing command transmitting device for transmitting a bonus game ending command to each of the gaming machines, corresponding to the results of the special game.

### TECHNICAL FIELD

The present invention relates to a gaming machine such as a slot machine, pachi-slot machine, video poker machine, etc., having: multiple changeable indication devices for changing and displaying multiple kinds of symbols necessary for the game; and control device such as a microcomputer or the like for controlling each of the multiple changeable indication devices so as to stop the motion thereof. Furthermore, the present invention relates to a gaming system and a management server including the gaming machine.

### BACKGROUND ART

Examples of conventional gaming machines of this kind include slot machines. With regard to the slot machine game, the player can bet a part of the inserted coins or a part of the credited coins. In this case, when the user operates a start lever, spin switch, or the like, the game begins. At the beginning of the slot machine game, multiple reels having symbols on the outer face thereof start to rotate. Subsequently, the rotation of each reel is stopped according to a predetermined procedure, whereupon one round of the game ends.

Examples of conventional gaming machines include the following gaming machine as follows. That is to say, in the event that the reels come to display a particular combination of the symbols or a single particular symbol in a first-stage game, a second-stage game (bonus game) is initiated in which the player is given an advantage in comparison with the first-stage game (see Japanese Unexamined Patent Application Publication No. 2003-62177, for example).

With such a gaming machine, in some cases, different kinds of the second-stage games are performed multiple times. The second-stage game is performed as follows. That is to say, first, the player selects one from among multiple choices. In cases in which the choice that is selected is correct, the player receives a predetermined profit such as coins, medals, or the like.

### DISCLOSURE OF THE INVENTION

There is a demand that such a gaming machine as described above be provided with a new form of amusement.

The present invention has been made in view of the aforementioned problems. Accordingly, it is an object thereof to provide a gaming machine and a management server which offers a new form of amusement, and a gaming system including such a gaming machine and management server.

In order to achieve the aforementioned object, the present invention provides a gaming machine as described below.

### MEANS FOR SOLVING THE PROBLEMS

(1) As an aspect of the present invention, a gaming system (e.g., a gaming system 100 described later in the first embodiment, a gaming system 200 described later in the second embodiment, etc.) comprises: multiple gaming machines (e.g., gaming machines 1a through 1h, etc., described later) including special game initiation device (e.g., main control circuit 71, device for performing processing in Step S19 shown in FIG. 29, etc., described later) for initiating a special game (e.g., bonus game, etc., described later) in which a player is given an advantage in comparison with a basic game (e.g., a slot game, etc., described later), and game value providing device (e.g., main control circuit 71, device for performing processing in Step S210 shown in FIG. 32, a hopper 30, a hopper driving circuit 32, etc., described later) for providing the player with a game value (e.g., coins, etc., described later); and a management server (e.g., management server 80 described later in the first embodiment, gaming machine 1a described later in the second embodiment, etc.) which is connected to the aforementioned multiple gaming machines via a communication device (e.g., LAN cable, etc., described later), and which has a function of centrally managing the amount of the game value paid out from each gaming machine. Within such a gaming system, each of the aforementioned multiple gaming machine includes: special game information transmitting device (e.g., main control circuit 71, device for performing the processing in Step S11 shown in FIG. 29, transmission port 128, etc.) for transmitting special game information (e.g., bonus game start information, etc., described later), which is a notification of a special game having been initiated by the aforementioned special game initiation device, via the aforementioned communication device; and special game participation information transmitting device (e.g., main control circuit 71, device for performing the processing in Step S15 shown in FIG. 29, communication port 128, etc., as described later) for transmitting special game participation information (e.g., bonus game participation information, etc., described later), which notifies the management server of the participation in the special game. The aforementioned management server includes: special game information receiving device (e.g., CPU 81, communication ports 84a through 84h, device for performing the processing in Step S103 shown in FIG. 30, described later in the first embodiment, and main control circuit 71a, communication ports 129b through 129h, and device for performing the processing in Step S412 shown in FIG. 36, described later in the second embodiment, etc.) for receiving the special game information transmitted by the aforementioned special game information transmitting device via the aforementioned communication device; special game initiation information transmitting device (e.g., CPU 81, communication ports 84a through 84h, device for performing the processing in Step S103 shown in FIG. 30, described later in the first embodiment, main control circuit 71a, communication ports 129b through 129h, device for performing the processing in Step S420 shown in FIG. 37, described later in the second embodiment, etc.) for transmitting special game initiation information (e.g., bonus game start notice command, etc., described later), which is a notification of the aforementioned special game having been initiated, to the gaming machines other than the gaming machine where the aforementioned special game has been initiated, via the aforementioned communication device; special game participation information receiving device (e.g., CPU 81, communication ports 84a through 84h, device for performing the processing in Step S105 shown in FIG. 30, described later in the first embodiment, and main control circuit 71a, communication ports 129b through 129h, device for performing the processing in Step S422 shown in FIG. 37, described later in the second embodiment, etc.) for receiving the aforementioned special game participation information from the aforementioned multiple gaming machines via the aforementioned communication device; and game value providing command transmitting device (e.g., CPU 81, communication ports 84a through 84h, device for performing the processing in Step S119 shown in FIG. 31, described later in the first embodiment, and main control circuit 71a, communication ports 129b through 129h, device for performing the processing in Step S443 shown in FIG. 39, described later in the second embodiment, etc.) for transmitting a command (e.g., bonus game ending command, etc., described later), which instructs the aforementioned game value providing device to provide each player with a game value corresponding to the results of the aforementioned special game (e.g., “victory”, “escape”, and “defeat”, etc., described later), to the gaming machines via the aforementioned communication device.

In an arrangement according to the invention described in (1), each of the multiple gaming machines includes: special game information transmitting device for transmitting special game information to the management server, which notifies the management server that a special game has been initiated by the special game initiation device; and special game participation transmitting device for transmitting special game participation information to the management server, which notifies the management server of the participation in the special game. Furthermore, the management server includes: special game information receiving device for receiving the special game information transmitted by the special game information transmitting device; special game initiation information transmitting device for transmitting special game initiation information to the gaming machines other than the gaming machine where the special game has been initiated, which notifies the gaming machines of the initiation of the special game; special game participation information receiving device for receiving the special game participation information from the multiple gaming machines via communication device; and game value providing command transmitting device for transmitting a command to the gaming machines, which instructs the game value providing device to provide the players with game values corresponding to the results of the special game. Such an arrangement offers a new form of amusement.

Let us consider a case in which a special game has been initiated by a player at any given one of the multiple machines. In this case, such an arrangement permits the other players, at the gaming machines other than the gaming machine where the special game has been initiated, to participate in the special game, in addition to providing the special game to the player who has initiated the special game. This provides a gaming system that offers amusement in an open and cooperative manner, unlike conventional gaming machines which operate in a closed and solitary manner, specifically, in a manner which provides a special game to only the gaming machine where the special game has been initiated.

Also, such an arrangement provides game values to the players corresponding to the results of the special game. This motivates the players to play their own roles in the special game in a cooperative manner. This offers a new kind of amusement in which the players play a game in a cooperative manner, in addition to the amusement of a conventional game in which the player plays a game in a solitary manner.

(2) In an arrangement according to a gaming system disclosed in (1), an arrangement may be made in which the game value providing command transmitting device of the management server transmits a command, which instructs the game value providing device to provide a game value, to each of the multiple gaming machines, such that there is difference in the game value, provided by the game value providing device (e.g., there is difference in the coin payment amount as described later), between the gaming machine that has transmitted the special game information via the special game information transmitting device and the other gaming machines that have not transmitted the special game information.

In such an arrangement according to the invention described in (2), there is a difference in the game value to be paid out to the player between the gaming machine that has transmitted the special game information and the other gaming machines that have not transmitted the special game information. This ensures the fairness among the players, thereby avoiding a situation in which the players lose interest in the game.

Let us consider an arrangement in which there is no difference in the game value to be paid out between the players at the gaming machine where the special game has been initiated and the other gaming machines where the players participate in this special game. Such an arrangement is unfair with respect to the relation between the player who has struggled to initiate the special game and the players who can participate in this bonus game at almost no costs. Accordingly, such an arrangement can adversely affect the interest of the player in the game. However, with the arrangement described in (2), there is a difference in the game value to be paid out between the players at the gaming machine where the special game has been initiated and the other gaming machines where the players participate in this special game. This ensures fairness among the players, thereby avoiding a situation in which the players lose interest in the game.

(3) Within a gaming system described in (1) or (2), an arrangement may be made in which the game value providing command transmitting device of the management server transmits a command, which instructs the game value providing device to provide a game value, to each of the multiple gaming machines, such that the game value providing device provides game values corresponding to the results of the special game (e.g., “victory”, “escape”, “defeat”, etc., as described above).

With such an arrangement according to the invention described in (3), the game value provided to the player varies corresponding to the results of the special game. This offers a new form of amusement in the game, in addition to the amusement of the special game provided by conventional gaming machines. This increases the player's level of interest in the game.

Let us consider a game which provides a special game in which the player plays an allied character role in a battle game to destroy a dragon. With such a game, each of the actions of the allied characters, e.g., commands such as “attack”, “magic”, “escape”, etc., affects the results of the special game, and accordingly, each of these actions affects the game value provided to each player. This increases the player's level of interest with respect to strategy, e.g., what command the player should select, thereby improving the amusement value of the game.

(4) In another aspect of the present invention, a management server employed in a gaming system (e.g., gaming system 100 described later in the first embodiment, a gaming system 200 described later in the second embodiment, etc.) comprises: multiple gaming machines (e.g., gaming machines 1a through 1h, etc., as described later) including special game initiation device (e.g., main control circuit 71, device for performing processing in Step S19 shown in FIG. 29, etc., described later) for initiating a special game (e.g., bonus game, etc., described later) in which the player is given an advantage in comparison with a basic game (e.g., a slot game, etc., described later), and game value providing device (e.g., main control circuit 71, device for performing processing in Step S210 shown in FIG. 32, hopper 30, hopper driving circuit 32, etc., as described later) for providing the player with a game value (e.g., coins, etc., described later); and a management server (e.g., management server 80 described later in the first embodiment, gaming machine 1a described later in the second embodiment, etc.) which is connected to the aforementioned multiple gaming machines via communication device (e.g., LAN cable, etc., as described later), and which has a function of centrally managing the amount of the game value paid out from each gaming machine. With such an arrangement, the management server includes: special game information receiving device (e.g., CPU 81, communication ports 84a through 84h, device for performing the processing in Step S103 shown in FIG. 30, as described later in the first embodiment, and main control circuit 71a, communication ports 129b through 129h, and device for performing the processing in Step S412 shown in FIG. 36, as described later in the second embodiment, etc.) for receiving special game information (e.g., bonus game start information, etc., described later), which is a notification of the special game having been initiated, from at least one of the aforementioned multiple gaming machines via the aforementioned communication device; special game initiation information transmitting device (e.g., CPU 81, communication ports 84a through 84h, device for performing the processing in Step S103 shown in FIG. 30, as described later in the first embodiment, main control circuit 71a, communication ports 129b through 129h, device for performing the processing in Step S420 shown in FIG. 37, as described later in the second embodiment, etc.) for transmitting special game initiation information (e.g., bonus game start notice command, etc., described later), which is a notification that the aforementioned special game has been initiated, to the gaming machines other than the gaming machine that has transmitted the aforementioned special game information, via the aforementioned communication device; special game participation information receiving device (e.g., CPU 81, communication ports 84a through 84h, device for performing the processing in Step S105 shown in FIG. 30, as described later in the first embodiment, and main control circuit 71a, communication ports 129b through 129h, device for performing the processing in Step S422 shown in FIG. 37, as described later in the second embodiment, etc.) for receiving the aforementioned special game participation information, which notifies the management server of the participation in the special game, from the aforementioned multiple gaming machines via the aforementioned communication device; and game value providing command transmitting device (e.g., CPU 81, communication ports 84a through 84h, device for performing the processing in Step S119 shown in FIG. 31, as described later in the first embodiment, and main control circuit 71a, communication ports 129b through 129h, device for performing the processing in Step S443 shown in FIG. 39, as described later in the second embodiment, etc.) for transmitting a command (e.g., bonus game ending command, etc., described later), which instructs the aforementioned game value providing device to provide each player with a game value corresponding to the results of the aforementioned special game (e.g., “victory”, “escape”, and “defeat”, etc., as described later), to the gaming machines via the aforementioned communication device.

In an arrangement according to the present invention described (4), the management server comprises: special game information receiving device for receiving special game information from at least one of the multiple gaming machines through the communication device, which notifies the management server of the initiation of the special game; special game initiation information transmitting device for transmitting special game initiation information to the gaming machines other than the gaming machine that has transmitted the special game information through the communication device, which notifies the gaming machines of the initiation of the special game; special game participation information receiving device for receiving special game participation information from the multiple gaming machines through the communication device, which notifies the management server of the participation in the special game; and game value providing command transmitting device for transmitting a command to the gaming machines through the communication device, which instructs the game value providing device to provide the players with game values corresponding to the results of the special game.

Let us consider cases in which a special game has been initiated by a player at any given one of the multiple machines. In this case, such an arrangement permits the other players, at the gaming machines other than the gaming machine where the special game has been initiated, to participate in the special game, in addition to providing the special game to the player who has initiated the special game. This provides a gaming system that offers amusement in an open and cooperative manner, unlike conventional gaming machines which operate in a closed and solitary manner, specifically, in a manner which provides a special game only to the gaming machine where the special game has been initiated.

Also, such an arrangement provides game values to the players corresponding to the results of the special game. This motivates the players to play their own roles in the special game in a cooperative manner. This offers a new kind of amusement in which the players play a game in a cooperative manner, in addition to the amusement of a conventional game in which the player plays a game in a solitary manner.

(5) With the management server described in (4), an arrangement may be made in which the game value providing command transmitting device transmit a command, which instructs the game value providing device to provide a game value, to each of the multiple gaming machines, such that there is difference in the game value, provided by the game value providing device (e.g., there is a difference in the coin payment amount described later), between at least one gaming machine of the multiple gaming machines and the other gaming machines.

In such an arrangement according to the invention described in (5), there is a difference in the game value to be paid out to the player between at least one gaming machine (gaming machine that has transmitted the special game information) among the multiple gaming machines and the other gaming machines. This ensures the fairness among the players, thereby avoiding a situation in which the players lose interest in the game.

Let us consider an arrangement in which there is no difference in the game value to be paid out between at least one player at a particular gaming machine (where the player has initiated a special game) among the multiple gaming machines and the other players who participate in this special game. Such an arrangement is unfair with respect to the relation between the player who has struggled to initiate the special game and the players who can participate in this bonus game at almost no costs. Accordingly, such an arrangement can adversely affect the interest of the player in the game. With the arrangement described in (5), there is a difference in the game value to be paid out between at least one player at a particular gaming machine (where the player has initiated a special game) among the multiple gaming machines and the other players who participate in this special game. This ensures fairness among the players, thereby avoiding a situation in which the players lose interest in the game.

(6) With the management server described in (4) or (5), an arrangement may be made in which the game value providing command transmitting device transmit a command, which instructs the game value providing device to provide a game value, to each of the multiple gaming machines, such that the game value providing device provide game values corresponding to the results of the special game (e.g., “victory”, “escape”, “defeat”, etc., as described later).

With such an arrangement according to the invention described in (6), the game value provided to the player varies corresponding to the results of the special game. This offers a new form of amusement in the game, in addition to the amusement of the special game provided by conventional gaming machines.

Let us consider a game which provides a special game in which the player plays an allied character role in a battle game to destroy a dragon. With such a game, each of the actions of the allied characters, e.g., commands such as “attack”, “magic”, “escape”, etc., affects the results of the special game, and accordingly, each of these actions affects the game value provided to each player. This increases the player's level of interest with respect to strategy, e.g., what command the player should select, thereby improving the amusement value of the game.

(7) In yet another aspect of the present invention, a gaming machine employed in a gaming system (e.g., gaming system 100 described later in the first embodiment, a gaming system 200 described later in the second embodiment, etc.) comprises: multiple gaming machines which are connected to the gaming system via communication device (e.g., LAN cable, etc., as described later), and which include special game initiation device (e.g., main control circuit 71, device for performing processing in Step S19 shown in FIG. 29, etc., described later) for initiating a special game (e.g., bonus game, etc., described later) in which a player is given an advantage in comparison with a basic game (e.g., a slot game, etc., described later), and game value providing device (e.g., main control circuit 71, device for performing processing in Step S210 shown in FIG. 32, hopper 30, hopper driving circuit 32, etc., described later) for providing the player with a game value (e.g., coins, etc., described later); and a management server (e.g., management server 80 described later in the first embodiment, gaming machine 1a described later in the second embodiment, etc.) which is connected to the aforementioned multiple gaming machines via the aforementioned communication device, and which has a function of centrally managing the amount of the game value paid out from each gaming machine. With such an arrangement, the gaming machine includes: special game information transmitting device (e.g., main control circuit 71, device for performing the processing in Step S11 shown in FIG. 29, transmission port 128, etc., as described later) for transmitting special game information (e.g., bonus game start information, etc., described later), which is a notification of a special game having been initiated by the aforementioned special game initiation device, via the aforementioned communication device; special game initiation information receiving device (e.g., main control circuit 71, device for performing the processing in Step S202 shown in FIG. 32, communication port 128, etc., as described later) for receiving special game initiation information (e.g., bonus game start command, etc., described later), which is a notification of the initiation of the special game, via the aforementioned communication device; special game participation information transmitting device (e.g., main control circuit 71, device for performing the processing in Step S15 shown in FIG. 29, communication port 128, etc., as described later) for transmitting special game participation information (e.g., bonus game participation information, etc., as described later), which notifies the management server of the participation in the special game; and game value providing command receiving device (e.g., main control circuit 71, device for performing the processing in Step S209 shown in FIG. 32, communication port 128, etc., as described above) for receiving a command (e.g., bonus game ending command, etc., described above), which instructs the aforementioned game value providing device to provide a game value to the player, from the aforementioned management server via the aforementioned communication device.

In such an arrangement according to the present invention described in (7), the gaming machine comprises: special game information transmitting device for transmitting special game information to the management server via the communication device, which notifies the management server of a special game having been initiated by the special game initiation device; special game initiation information receiving device for receiving special game initiation information from the management server via the communication device, which notifies the gaming machine of the initiation of a special game; special game participation transmitting device for transmitting special game participation information to the management server via the communication device, which notifies the management server of the participation in the special game; and game value providing command receiving device for receiving a command from the management server via the communication device, which instructs the game value providing device to provide a game value. This kind of arrangement offers a new form of amusement.

Let us consider cases in which a special game has been initiated by a player at any given one of the multiple machines. In this case, such an arrangement permits the other players, at the gaming machines other than the gaming machine where the special game has been initiated, to participate in the special game, in addition to providing the special game to the player who has initiated the special game. This provides a gaming system that offers amusement in an open and cooperative manner, unlike conventional gaming machines which operate in a closed and solitary manner, specifically, in a manner which provides a special game to only the gaming machine where the special game has been initiated.

Also, such an arrangement provides game values to the players corresponding to the results of the special game. This motivates the players to play their own roles in the special game in a cooperative manner. This offers a new kind of amusement in which the players play a game in a cooperative manner, in addition to the amusement of a conventional game in which the player plays a game in a solitary manner.

(8) With the gaming machine described in (7), an arrangement may be made in which the game value providing command receiving device receives a command from the management server, which instructs the game value providing device to provide game values that differ in amount between a case in which the special game information has been transmitted through the special game information transmitting device and a case in which the special game information has not been transmitted through the special game information transmitting device.

In such an arrangement according to the invention described in (8), there is a difference in the game value to be paid out to the player between the gaming machine that has transmitted the special game information and the other gaming machines that have not transmitted the special game information. This ensures fairness among the players, thereby avoiding a situation in which the players lose interest in the game.

Let us consider an arrangement in which there is no difference in the game value to be paid out between the players at the gaming machine where the special game has been initiated and the other gaming machines where the players participate in this special game. Such an arrangement is unfair with respect to the relation between the player who has struggled to initiate the special game and the players who can participate in this bonus game at almost no costs. Accordingly, such an arrangement can adversely affect the interest of the player in the game. With the arrangement described in (2), there is a difference in the game value to be paid out between the players at the gaming machine where the special game has been initiated and the other gaming machines where the players participate in this special game. This ensures fairness among the players, thereby avoiding a situation in which the players lose interest in the game.

(9) With the gaming machine described in (7) or (8), an arrangement may be made in which the game value providing command receiving device receives a command from the management server, which instructs the game value providing device to provide a game value corresponding to the results of the special game (e.g., “victory”, “escape”, “defeat”, etc., as described later).

In such an arrangement according to the present invention described in (9), the game value provided to the player varies corresponding to the results of the special game. This offers a new form of amusement in the game, in addition to the amusement of the special game provided by conventional gaming machines.

Let us consider a game which provides a special game in which the player plays an allied character role in a battle game to destroy a dragon. In such a game, each of the actions of the allied characters, e.g., commands such as “attack”, “magic”, “escape”, etc., affects the results of the special game, and accordingly, each of these actions affects the game value provided to each player. This increases the player's level of interest with respect to strategy, e.g., what command the player should select, thereby improving the amusement value of the game.

(10) In yet another aspect of the present invention, a gaming system comprises: a first gaming machine which provides a basic game and a special game in which a player is given an advantage in comparison with the basic game; a management server having the function of transmission/reception of information to and from the first gaming machine; and a second gaming machine having the function of transmission/reception of information to and from the management server. In such an arrangement, in cases in which the game stage being executed by the first gaming machine has switched from the basic game stage to the special-game stage, the first gaming machine transmits special game information to the management server, which notifies the management server of the initiation of the special game. Upon reception of special game information, the management server creates special game participation selection information based upon the special game information, and transmits the special game participation selection information to the second gaming machine. Furthermore, the second gaming machine provides the player at the second gaming machine with the special game participation selection information. When the player at the second gaming machine inputting participation selection inputs data, the second gaming machine creates special game participation information based upon the participation selection input data, and transmits the special game participation information to the management server. Furthermore, the management server transmits a start command for the special game to the first gaming machine and the second gaming machine according to the special game participation information. Furthermore, the management server transmits progress information to the first and second gaming machines during the progress of the special game while receiving input data from the players at the first gaming machine and/or the player at the second gaming machine, in order to advance the special game. Furthermore, the management server creates command information based upon the results of the special game and transmits the command information to the first and second gaming machines, which instructs the first gaming machine and/or the second gaming machine to provide each player with a corresponding game value.

(11) The gaming system described in the above (10) may further comprise a third gaming machine having the function of transmission/reception of information to/from the management server. In such an arrangement, in cases in which the management server has not received the special game participation information from the third gaming machine in a predetermined period of time after the management server has transmitted the special game participation selection information to the third gaming machine, the management server does not transmit information for the special game to the third gaming machine.

(12) With the gaming system described in the above (10) or (11), an arrangement may be made in which the management server transmits the command information to the first gaming machine and/or the second gaming machine, so as to provide the players at the first gaming machine and the second gaming machine with different game values.

(13) In yet another aspect of the present invention, a management server has a function of transmission/reception of information to and from a first gaming machine and a second gaming machine each of which provides a basic game and a special game in which a player is given an advantage in comparison with the basic game. With such an arrangement, the management server receives special game information transmitted from the first gaming machine, which notifies the management server of the initiation of the special game, creates special game participation selection information based upon the special game information, and transmits the special game participation selection information to the second gaming machine. In cases in which the second gaming machine has created special game participation information based upon participation selection input data input by the player, the management server receives the special game participation information from the second gaming machine, and transmits a start command for the special game to each of the first and second gaming machine. Furthermore, the management server transmits progress information to the first and second gaming machines during the progress of the special game while receiving input data from the player at the first gaming machine and/or the player at the second gaming machine, in order to advance the special game. Furthermore, the management server creates command information based upon the results of the special game and transmits the command information to the first and second gaming machines, which instructs the first gaming machine and/or the second gaming machine to provide each player with a corresponding game value.

(14) With the management server described in the above (13), the management server may have the function of transmission/reception of information to and from a third gaming machine. With such an arrangement, in cases in which the management server has not received the special game participation information from the third gaming machine in a predetermined period of time after the management server has transmitted the special game participation selection information to the third gaming machine, the management server does not transmit information for the special game to the third gaming machine.

(15) With the management server described above (13) or (14), the management server may transmit the command information to the first gaming machine and/or the second gaming machine, so as to provide different game values to the players at the first gaming machine and the second gaming machine.

(16) In yet another aspect of the present invention, a first gaming machine which comprises a display for displaying information regarding a game, a receiver that allows a player to input data for starting a game, and a control device for controlling the progress of the game. Furthermore, the first gaming machine has the function of providing a basic game and a special game in which the player is given an advantage in comparison with the basic game. With such an arrangement, the first gaming machine has a function of transmission/reception of information to/from a second gaming machine. In cases in which the game stage being executed by the first gaming machine has switched from the basic game stage to the special-game stage, the first gaming machine creates special game participation selection information based upon special game information which is a notification that the special game is to be initiated, and transmits the special game participation selection information to the second gaming machine. Furthermore, the second gaming machine provides the special game participation selection information to the player at the second gaming machine, creates special game participation information based upon participation selection input data input by the player at the second gaming machine, and transmits the special game participation information to the first gaming machine. Furthermore, the first gaming machine creates a start command for the special game based upon the special game participation information, which instructs the first gaming machine to start the special game, and which is transmitted to the second gaming machine. Furthermore, the first gaming machine transmits progress information to the second gaming machine during the progress of the special game while receiving the input data input by the players at the first gaming machine and/or the second gaming machine directly or through the second gaming machine, in order to advance the special game. Furthermore, the first gaming machine creates command information based upon the results of the special game and transmits the command information to second gaming machine, which instructs the first gaming machine and/or the second gaming machine to provide each player with a corresponding game value.

(17) In yet another aspect of the present invention, a second gaming machine comprises a display for displaying information regarding a game, a receiver that allows a player to input data, and a control device for controlling the progress of the game. Furthermore, the second gaming machine has the function of providing a special game in which the player is given an advantage in comparison with a basic game. In such an arrangement, the second gaming machine has a function of transmission/reception of information to/from a first gaming machine having a function of transmitting special game participation selection information based upon special game information that notifies the second gaming machine of the initiation of the special game. Furthermore, the second gaming machine provides the special game participation selection information to the player at the second gaming machine, creates special game participation information based upon participation selection input data input by the player at the second gaming machine, and transmits the special game participation information to the first gaming machine. Furthermore, the second gaming machine receives a start command for the special game transmitted from the first gaming machine. Furthermore, the second gaming machine receives the progress information from the first gaming machine during the progress of the special game while receiving the input data input by the player at the second gaming machine, in order to advance the special game. Furthermore, the second gaming machine receives command information corresponding to the results of the special game from the first gaming machine, which instructs the second gaming machine to provide a corresponding game value to the player at the second gaming machine.

(18) In yet another aspect of the present invention, a network gaming machine system comprises: a first gaming machine which comprises a display for displaying information regarding a game, a receiver that allows a player to input data for starting a game, and a control device for controlling the progress of the game, and which provides a basic game and a special game in which the player is given an advantage in comparison with the basic game; a network to which the first gaming machine is connected; and a second gaming machine which is connected to the network, and can be connected to the first gaming machine via the network. In such an arrangement, the second gaming machine comprises a display for displaying the information regarding the game, a receiver that allows a player to input data for starting a game, and a control device for controlling the progress of the game, and which has the function of providing a basic game and a special game in which the player is given an advantage in comparison with the basic game. In cases in which the game stage being executed by the first gaming machine has switched from the basic game stage to the special-game stage, the first gaming machine creates special game participation selection information based upon special game information, which is a notice that the special game is to be initiated, and transmits the special game participation selection information to the second gaming machine. Furthermore, the second gaming machine provides the special game participation selection information to the player at the second gaming machine, creates special game participation information based upon participation selection input data input by the player at the second gaming machine, and transmits the special game participation information to the first gaming machine. In addition, the first gaming machine creates a start command for the special game based upon the special game participation information, which instructs the first gaming machine to start the special game, and which is transmitted to the second gaming machine. Moreover, the first gaming machine transmits progress information to the second gaming machine during the progress of the special game while receiving the input data input by the players at the first gaming machine and/or the second gaming machine directly or through the second gaming machine, in order to advance the special game. Furthermore, the first gaming machine creates command information based upon the results of the special game and transmits the command information to second gaming machine, which instructs the first gaming machine and/or the second gaming machine to provide each player with a corresponding game value.

The special game participation selection information may be the information which notifies the players, at the gaming machines other than the gaming machine where a special game has been initiated, that each player can select to participate or not to participate in the special game. The participation selection input data may be the input data of an offer to participate in the special game, made by the player who has received the aforementioned special game participation selection information. The participation selection input data may be input through any device, e.g., a button, keyboard, mouse, voice input device, etc. The progress information may be information for indicating the progress of the special game over time, and change in the state of the special game. The command information which provides the player at the first gaming machine and/or the player at the second gaming machine with a predetermined game value may be information for instructing each gaming machine to provide a predetermined value to the player. The game value may be provided by any method, e.g., in the form of coins paid out through a hopper or the like, and in the form of information, i.e., credits.

### BRIEF DESCRIPTION OF THE DRAWINGS

FIG. 1 is a perspective view which shows the exterior of a gaming machine 1 which is a component of a gaming system according to a first embodiment.

FIG. 2 is a diagram which shows a main display of the gaming machine which is a component of the gaming system according to the first embodiment.

FIG. 3 is a second display of the gaming machine which is a component of the gaming system according to the first embodiment.

FIG. 4 is a diagram which shows sequence of symbols depicted on each reel which is a component of the gaming system according to the first embodiment.

FIG. 5 is a diagram which shows a payout table for the gaming machine which is a component of the gaming system according to the first embodiment.

FIG. 6 is a diagram which shows a selection probability table for the reels of the gaming machine which is a component of the gaming system according to the first embodiment.

FIG. 7 is an explanatory diagram which shows an overall configuration of the gaming system according to the first embodiment.

FIG. 8 is a block diagram which shows a configuration of an electric circuit included in the gaming machine which is a component of the gaming system according to the first embodiment.

FIG. 9 is a block diagram which shows a configuration of an electric circuit of a sub-control circuit included in the gaming machine which is a component of the gaming system according to the first embodiment.

FIG. 10 is a block diagram which shows a configuration of an electric circuit of a management server which is a component of the gaming system according to the first embodiment.

FIG. 11A is a diagram which shows a standard coin payment table stored in ROM included in the management server which is a component of the gaming system according to the first embodiment.

FIG. 11B is a diagram which shows a betting classification table stored in ROM included in the management server which is a component of the gaming system according to the first embodiment.

FIG. 11C is a diagram which shows a treasure-box coin amount table stored in ROM included in the management server which is a component of the gaming system according to the first embodiment.

FIG. 12A is a diagram for specifically describing the coin payment amount paid out to a leader from the gaming machine which is a component of the gaming system according to the first embodiment.

FIG. 12B is a diagram for specifically describing the coin payment amount paid out to a partner from the gaming machine which is a component of the gaming system according to the first embodiment.

FIG. 13 is a diagram which shows an example of a bonus game displayed on a second display of the gaming machine which is a component of the gaming system according to the first embodiment.

FIG. 14 is a diagram which shows an example of a bonus game displayed on the second display of the gaming machine which is a component of the gaming system according to the first embodiment.

FIG. 15 is a diagram which shows an example of a bonus game displayed on the second display of the gaming machine which is a component of the gaming system according to the first embodiment.

FIG. 16 is a diagram which shows an example of a bonus game displayed on the second display of the gaming machine which is a component of the gaming system according to the first embodiment.

FIG. 17 is a diagram which shows an example of a bonus game displayed on the second display of the gaming machine which is a component of the gaming system according to the first embodiment.

FIG. 18A is a diagram which shows an example of a bonus game displayed on the second display of the gaming machine where the player plays a lead character role, and which is a component of the gaming system according to the first embodiment.

FIG. 18B is a diagram which shows an example of a bonus game displayed on the second display of the gaming machine where the player plays a partner character role, and which is a component of the gaming system according to the first embodiment.

FIG. 19 is a diagram which shows an example of a bonus game displayed on the second display of the gaming machine which is a component of the gaming system according to the first embodiment.

FIG. 20 is a diagram which shows an example of a bonus game displayed on the second display of the gaming machine which is a component of the gaming system according to the first embodiment.

FIG. 21A is a diagram which shows an example of a bonus game displayed on the second display of the gaming machine which is a component of the gaming system according to the first embodiment.

FIG. 21B is a diagram which shows an example of a bonus game displayed on the second display of the gaming machine which is a component of the gaming system according to the first embodiment.

FIG. 22 is a diagram which shows an example of a bonus game displayed on the second display of the gaming machine which is a component of the gaming system according to the first embodiment.

FIG. 23 is a diagram which shows an example of a bonus game displayed on the second display of the gaming machine which is a component of the gaming system according to the first embodiment.

FIG. 24A is a diagram which shows an example of a bonus game displayed on the second display of the gaming machine which is a component of the gaming system according to the first embodiment.

FIG. 24B is a diagram which shows an example of a bonus game displayed on the second display of the gaming machine which is a component of the gaming system according to the first embodiment.

FIG. 25 is a diagram which shows an example of a bonus game displayed on the second display of the gaming machine which is a component of the gaming system according to the first embodiment.

FIG. 26 is a diagram which shows an example of a bonus game displayed on the second display of the gaming machine which is a component of the gaming system according to the first embodiment.

FIG. 27A is a diagram which shows an example of a bonus game displayed on the second display of the gaming machine which is a component of the gaming system according to the first embodiment.

FIG. 27B is a diagram which shows an example of a bonus game displayed on the second display of the gaming machine which is a component of the gaming system according to the first embodiment.

FIG. 28 is a main flowchart for a main control circuit included in the gaming machine which is a component of the gaming system according to the first embodiment.

FIG. 29 is a flowchart of the steps subsequent to those shown in FIG. 28 for the gaming machine which is a component of the gaming system according to the first embodiment.

FIG. 30 is a flowchart for describing bonus game control processing for the management server which is a component of the gaming system according to the first embodiment.

FIG. 31 is a flowchart of the steps subsequent to those shown in FIG. 30 for the management server which is a component of the gaming system according to the first embodiment.

FIG. 32 is a flowchart for describing bonus game control processing for the gaming machine which is a component of the gaming system according to the first embodiment.

FIG. 33 is a flowchart for describing coin payment amount computation processing for the management server which is a component of the gaming system according to the first embodiment.

FIG. 34 is an explanatory diagram which shows an overall configuration of a gaming system according to a second embodiment.

FIG. 35 is a main flowchart for a main control circuit included in a gaming machine 1a which is a component of the gaming system according to the second embodiment.

FIG. 36 is a flowchart of the steps subsequent to those shown in FIG. 35 for the gaming machine 1a which is a component of the gaming system according to the second embodiment.

FIG. 37 is a flowchart of the steps subsequent to those shown in FIG. 36 for the gaming machine 1a which is a component of the gaming system according to the second embodiment.

FIG. 38 is a flowchart of the steps subsequent to those shown in FIG. 37 for the gaming machine 1a which is a component of the gaming system according to the second embodiment.

FIG. 39 is a flowchart of the steps subsequent to those shown in FIG. 38 for the gaming machine 1a which is a component of the gaming system according to the second embodiment.

FIG. 40 is a block diagram which shows a configuration of an electric circuit included in a gaming machine which is a component of the gaming system according to the second embodiment.

FIG. 41 is a flowchart for describing bonus game control processing for a management server which is a component of the gaming system according to a third embodiment.

FIG. 42 is a flowchart for describing bonus game start processing for the management server which is a component of the gaming system according to the third embodiment.

FIG. 43 is a schematic diagram which shows a network gaming system according to a fourth embodiment.

### PREFERRED MODE FOR CARRYING OUT THE INVENTION

### First Embodiment

Description will be made below regarding a first embodiment in which the present invention is applied to a gaming system 100 comprising multiple gaming machines 1 and a management server 80 which is a central payment device.

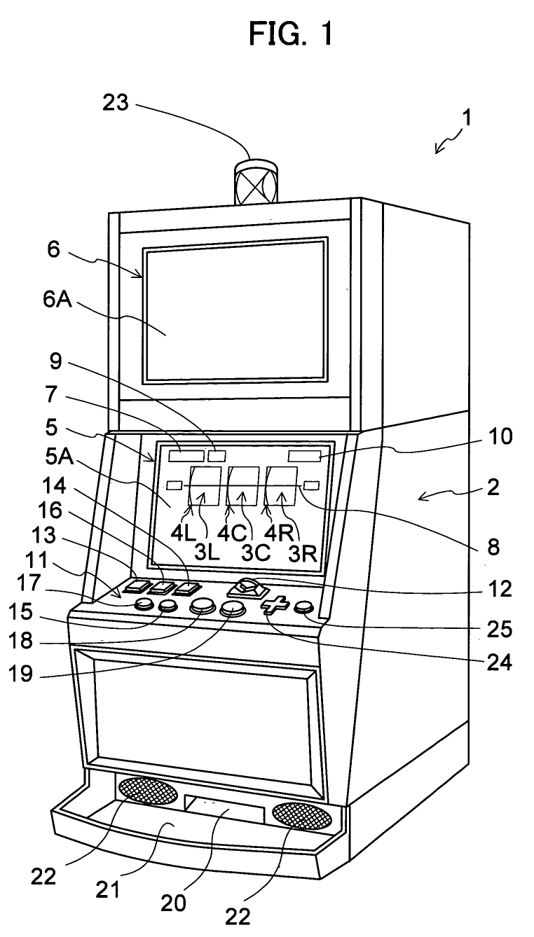

FIG. 1 is a perspective view which shows the exterior of a gaming machine 1 which is a component of the gaming system 100 according to an embodiment of the present invention. The gaming machine 1 is a so-called slot machine. The gaming machine 1 provides a game to the player through the use of coins, medals, balls, tokens, etc., or a game medium such as a card or the like, storing information regarding the value of the game which is provided to, or is to be provided to, the player. Description will be made regarding an arrangement in which the gaming machine 1 provides a game through the use of coins.

A main display 5 is formed on the lower portion of the front face of a casing 2 which is an overall framing member of the gaming machine 1. The main display 5 includes display windows 4L, 4C, and 4R each of which is formed in a rectangular shape which is taller than it is wide. A single value line 8 is marked at the center of each of the display windows 4L, 4C, and 4R.

The cabinet 2 formed as a front cover of the gaming machine 1 includes three reels 3L, 3C, and 3R therewithin, which are formed so as to be aligned with one another horizontally, and such that each reel is able to rotate. Furthermore, each of the reels 3L, 3C, and 3R has a sequence of symbols formed of multiple kinds of symbols depicted on the outer face thereof, thereby forming a changeable indication device. The symbols depicted on the reels can be observed through the display windows 4L, 4C, and 4R.

The gaming machine 1 includes a main display 5 in front of the reels 3L, 3C, and 3R, on the lower side of the casing 2, for digitally producing visual effects for a slot game and displaying a bonus game (description will be made later regarding the slot game and the bonus game) . Furthermore, the gaming machine 1 includes a second display 6 on the upper side of the casing 2, for digitally displaying the bonus game. Note that LCDs are employed as the main display 5 and the second display 6. A description will be made later regarding the main display 5 and the second display 6.

A description is being made herein regarding an arrangement in which LCDs are employed as the main display 5 and the second display 6 of the gaming machine 1 according to the present embodiment. That is to say, each display employs only an LCD. However, the present invention is not restricted to such an arrangement. Also, examples of display devices which can be employed as the main display 5 and the second display 6 include a CRT, plasma display, etc. Furthermore, one or multiple types of display devices can be employed to form the main display 5 and the second display 6.

In an ordinary game (which will be referred to as “slot game” hereafter), the main display 5 displays a PAID meter 7 and a BET meter 9 on the upper side of the display window 4L in the display region 5A thereof. Here, the PAID meter 7 displays a payout when a player wins. The BET meter 9 displays the number of the coins which are bet on a game. Furthermore, the main display 5 displays a CREDIT meter 10 on the upper side of the display window 4R in the display region 5A thereof, which displays the number of coins currently deposited.

Furthermore, a coin insertion opening 12 is provided to a control panel 11 positioned on the lower side of the main display 5, which allows the player to insert coins.

Furthermore, the control panel 11 includes a spin switch 15 which allows rotation of the reels 3L, 3C, and 3R to be initiated. Furthermore, the control panel 11 includes an error switch 13, help switch 14, cash out switch 16, BET switch 17, maximum BET spin switch 18, repeat BET spin switch 19, cross switch 24, and decision switch 25.

In the event that the gaming machine 1 makes an error, the player presses the error switch 13. Upon the error switch 13 being pressed, the error lamp 23 provided on the top face of the casing 2 is turned on, which summons the game area staff.

The help switch 14 allows the player to display, on the second display, information regarding matters which are unclear to the player. Examples of such information include the method for playing the gaming machine 1, information regarding the bonus game described later, etc.

The cash out switch 16 allows the deposited coins to be discharged to a coin tray 21 through a coin payment opening 20.

The BET switch 17 allows the player to bet the deposited coins. One coin is bet every time the BET switch 17 is pressed. Note that the number of the coins bet on one round of the game will be referred to as “BET number” hereafter.

The maximum BET spin switch 18 allows the player to bet the maximum number of the coins (four coins, for example), which can be bet in one round of the game, with a single press of the switch. Furthermore, upon the maximum BET spin switch 18 being pressed, the reels 3L, 3C, and 3R start to rotate.

The repeat BET switch 19 allows the player to bet the same number of coins as that of the previous BET number by pressing the switch. Furthermore, upon the repeat BET switch 19 being pressed, the reels 3L, 3C, and 3R start to rotate.

The cross switch 24 and the decision switch 25, which serve as input devices, allow the player to press the switch to select a desired command in the bonus game stage.

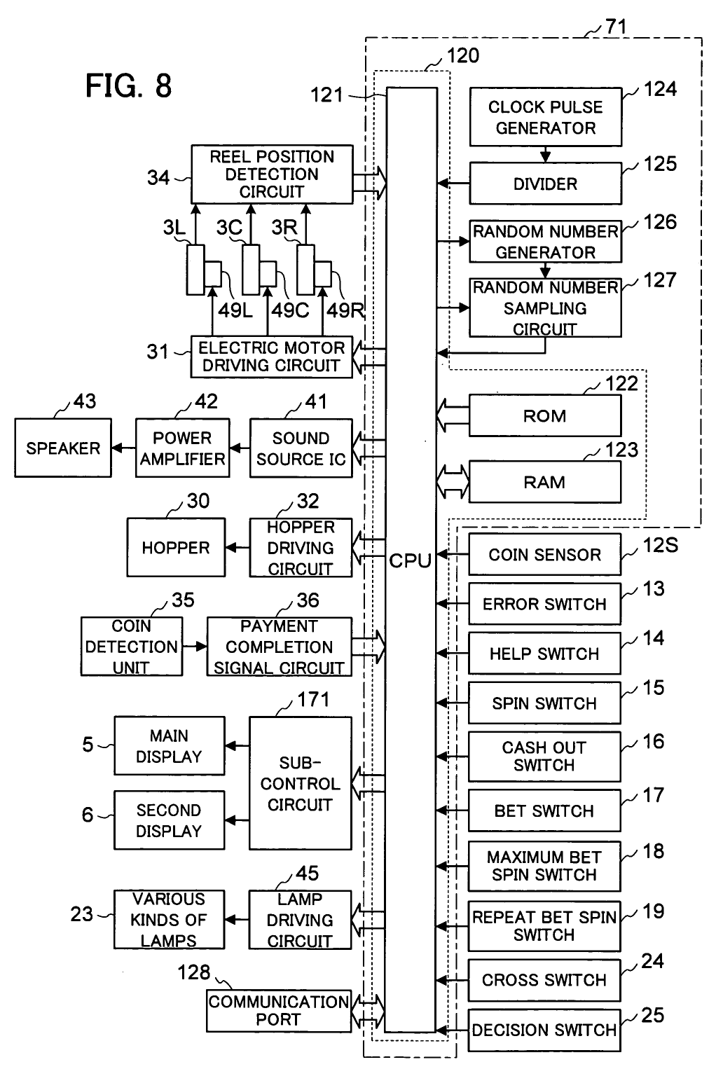

Furthermore, sound transmission openings 22 are provided on the upper side of the coin tray 21, which is a tray for receiving the discharged coins, in order to transmit to the exterior the sound generated by a speaker 43 (see FIG. 8) stored within the casing 2.

A description has been made in the present embodiment regarding an arrangement including the spin switch 15 or the repeat BET pin switch 19 which allows the player to initiate the rotation of the reels 3L, 3C, and 3R by pressing the switch. However, the present invention is not restricted to such an arrangement. Also, an arrangement may be made including a handle which allows the player to initiate the rotation of the reels 3L, 3C, and 3R by tilting the handle.

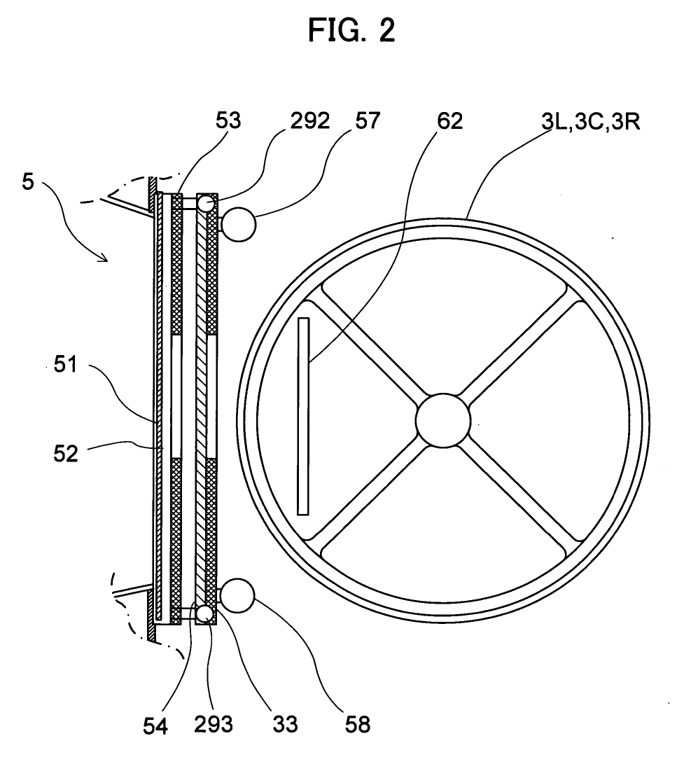

Next, a description will be made regarding the configuration of the main display 5, with reference to FIG. 2.

The gaming machine 1 includes the main display 5 on the lower side of the casing 2 thereof, and the second display 6 on the upper side of the casing 2 thereof.

FIG. 2 is a cross-sectional view which shows the main display 5 along with the reels 3L, 3C, and 3R. The main display 5 has a layered structure in which are layered (on the inner face of a transparent acrylic plate 52 which is a protection cover) a symbol sheet 53, formed of a transparent film member on which various kinds of symbols have been printed, a liquid crystal display device 54 formed of a transparent liquid crystal display device including pixel electrodes, and the like, and a light introducing plate 33. Furthermore, a touch panel 51 is provided on the front face thereof for detecting the coordinates of the portion where the player has touched.

Furthermore, the liquid crystal display device 54 includes a liquid crystal back lights 292 and 293 on the upper and lower sides thereof, which provide illumination to the liquid crystal display device 54. Turning on the liquid crystal back lights 292 and 293 allows the player to clearly see the image display on the liquid crystal display device 54.

The main display 5 includes symbol illumination lamps 57 and 58 at the upper and lower portions on the inner side thereof, which illuminate the symbols on the reels 3L, 3C, and 3R. The symbol illumination lamps 57 and 58 are controlled so as to be turned on when the power supply is engaged. This allows the symbols on the reels 3L, 3C, and 3R to be clearly seen. Although cold-cathode tubes are generally employed as the symbol illumination lamps 57 and 58, the present invention is not restricted to such an arrangement.

The symbols depicted on the symbol sheets 53 can be clearly seen by the player at all times, regardless of the visual effects produced by the gaming machine 1. The liquid crystal display device 54 displays not only an image for the slot game but also an image for the bonus game.

Each of the reels 3L, 3C, and 3R includes a lamp housing 62 mounting a reel back lamp (not shown) near the front face thereof, the operation of which allows the symbols depicted on the reels to be clearly seen.

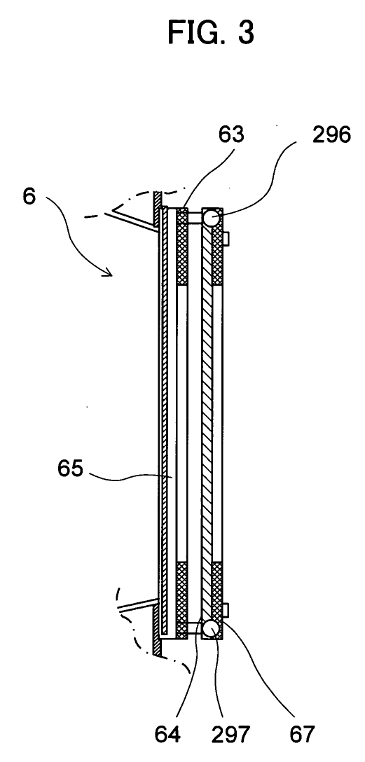

FIG. 3 is a cross-sectional view which shows the second display 6, which serves as a display device. The second display 6 has a layered structure in which are layered (on the inner face of a transparent acrylic plate 65) a symbol sheet 63, a liquid crystal display device 64, and a light introducing plate 67, in the same way as with the main display 5. Furthermore, liquid crystal back lights 296 and 297 are provided on the upper and lower sides of the liquid crystal display device 64. Note that a symbol illumination lamp is not provided since there are no reels provided on the rear side of the second display 6.

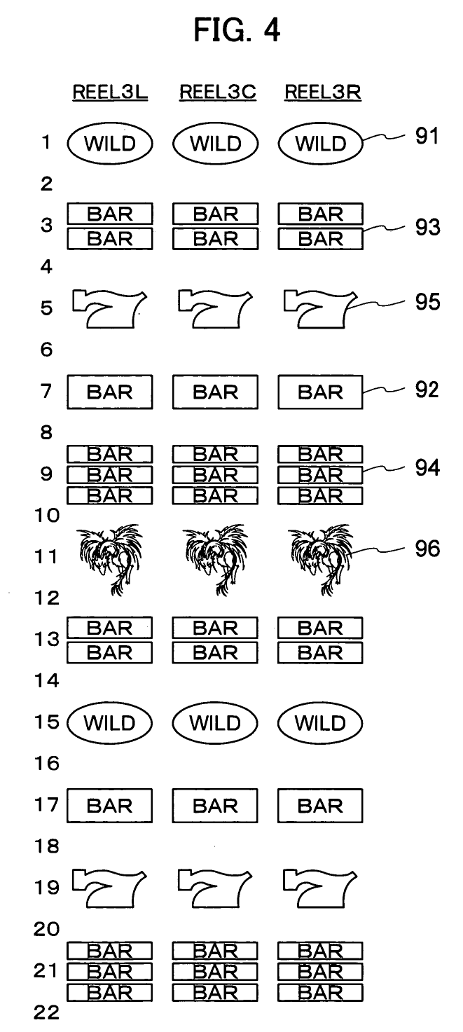

FIG. 4 shows sequence of symbols which are arrays of multiple kinds of symbols depicted on the reels 3L, 3C, and 3R. Each sequence of symbols is formed of multiple kinds of symbols, each of which is situated at an odd-numbered position, and multiple blanks, each of which is situated at an even-numbered position. Code numbers 1 through 22 are here assigned to these symbols and blanks. With such an arrangement, the symbols and blanks, and their corresponding code numbers are stored in ROM 122 (see FIG. 8) described later in the form of a table. The symbols depicted on each of the reels 3L, 3C, and 3R include: the WILD symbol (symbol 91), which consists of the word “WILD”; the 1BAR symbol (symbol 92), which consists of the word “BAR” written once; the 2BAR symbol (symbol 93), which consists of the word BAR written twice; the 3BAR symbol (symbol 94), which consists of the word “BAR” written three times; the red 7 symbol (symbol 95), which consists of the Arabic numeral “7” written in red; and the dragon symbol (symbol 96) which consists of a picture of a dragon.

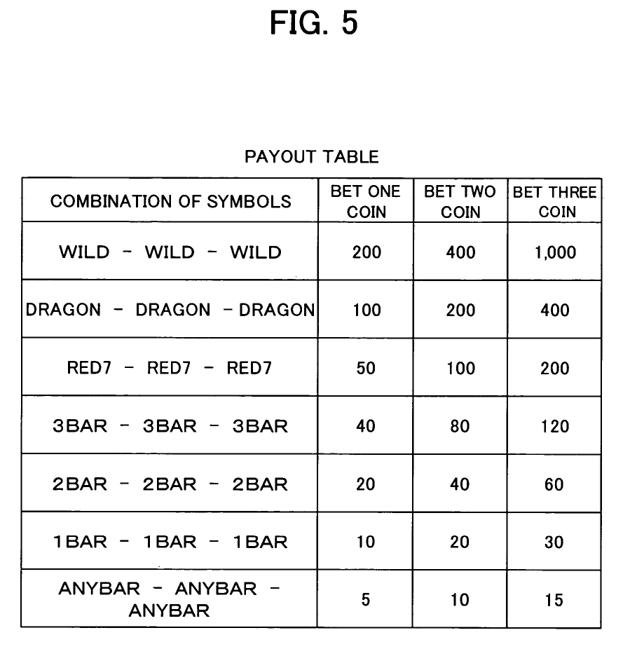

FIG. 5 is a payout table displayed on the second display 6 in the case of an ordinary game (slot game). The payout table shows the value of coins to be paid out for each winning combination.

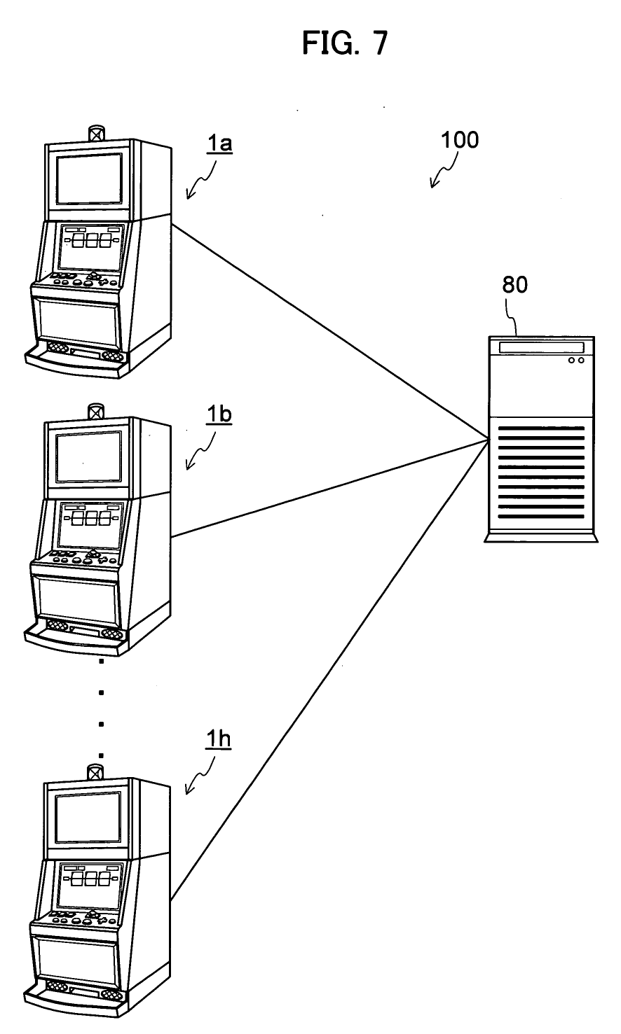

The game stages according to the present embodiment include two game stages, i.e., a slot game stage which provides a slot game, and a bonus game stage which provides a bonus game. The slot game is executed in the slot game stage according to the following procedure. That is to say, upon pressing the spin switch 15 after coins have been bet by pressing the BET switch 17, the reels 3L, 3C, and 3R start to rotate. In a normal state, the rotation of the reels 3L, 3C, and 3R stops, in that order, after a predetermined period of time. Also, upon pressing the maximum BET spin switch 18 or the repeat BET spin switch 19, the reels 3L, 3C, and 3R start to rotate in the same way. In cases in which the combination of the symbols displayed along the payline 8 matches a predetermined combination, i.e., a combination corresponding to the winning, the player wins coins.

Whereas, in cases in which a particular combination of the symbols is displayed in the slot game stage, i.e., the three dragon symbols are displayed along the payline, the game stage switches from the slot game stage to the bonus game stage. In the bonus game stage, a battle game (a game in which allied characters destroy a dragon which is an enemy character) described later is executed as a bonus game. In this bonus game stage, the player has a chance to win more coins than in the slot game stage. That is to say, in cases in which at least one gaming machine enters the battle game stage, all of the gaming machines 1a through 1h (see FIG. 7), which are connected via communication device (communication line) such as a LAN (local network) cable or the like through the management server 80, also enter the stage which allows the players to play the battle game.

Note that the term “symbol 1—symbol 2—symbol 3” as used here will represent hereafter the state in which the “symbol 1”, “symbol 2”, and “symbol 3” are displayed along the payline 8 positioned at the centers of the display windows 4L, 4C, and 4R, after the rotation of the reels stops.

A description will be made below regarding a case in which a combination of the symbols displayed along the payline 8 matches a predetermined combination in the slot game stage with reference to FIG. 5. Note that the combination of the symbols displayed along the payline 8 after the rotation of all the reels 3L, 3C, and 3R stops is determined using a selection probability table described later and the sampled random number.

As shown in FIG. 5, in cases in which a sequence of BARs, each of which may be any one of 1BAR, 2BAR, and 3BAR, is displayed along the payline 8 after the rotation of the reels 3L, 3C, and 3R stops, the player wins, irrespective of the order in which the kinds of BARs are displayed. That is to say, in cases in which the player has bet one coin, the player wins five coins. In cases in which the player has bet two coins, the player wins ten coins. In cases in which the player has bet three or four coins, the player wins fifteen coins.

Whereas, let us say that three 1BARs are displayed along the payline 8 after the rotation of the reels 3L, 3C, and 3R stops. In this case, in cases in which the player has bet one coin, the player wins ten coins. In cases in which the player has bet two coins, the player wins twenty coins. In cases in which the player has bet three or four coins, the player wins thirty coins.

Whereas, let us say that three 2BARs are displayed along the payline 8 after the rotation of the reels 3L, 3C, and 3R stops. In this case, in cases in which the player has bet one coin, the player wins twenty coins. In cases in which the player has bet two coins, the player wins forty coins. In cases in which the player has bet three or four coins, the player wins sixty coins.

Whereas, let us say that three 3BARs are displayed along the payline 8 after the rotation of the reels 3L, 3C, and 3R stops. In this case, in cases in which the player has bet one coin, the player wins forty coins. In cases in which the player has bet two coins, the player wins eighty coins. In cases in which the player has bet three or four coins, the player wins 120 coins.

Whereas, let us say that three red 7s are displayed along the payline 8 after the rotation of the reels 3L, 3C, and 3R stops. In this case, in cases in which the player has bet one coin, the player wins fifty coins. In cases in which the player has bet two coins, the player wins one hundred coins. In cases in which the player has bet three or four coins, the player wins two hundreds coins.

Whereas, let us say that three dragons are displayed along the payline 8 after the rotation of the reels 3L, 3C, and 3R stops. In this case, in cases in which the player has bet one coin, the player wins one hundred coins. In cases in which the player has bet two coins, the player wins two hundred coins. In cases in which the player has bet three or four coins, the player wins four hundreds coins. Subsequently, the game stage switches from the slot game stage to the bonus game stage.

Whereas, let us say that three WILDs are displayed along the payline 8 after the rotation of the reels 3L, 3C, and 3R stops. In this case, in cases in which the player has bet one coin, the player wins two hundred coins. In cases in which the player has bet two coins, the player wins four hundred coins. In cases in which the player has bet three or four coins, the player wins one thousand coins.

Note that the WILD symbol has a function as a wild card, substituting for the aforementioned symbols, i.e., 1BAR, 2BAR, 3BAR, and red 7. For example, the symbol combination “1BAR—1BAR—WILD” is equivalent to the symbol combination “1BAR—1BAR—1BAR”, i.e., so-called a 1BAR winning, since the WILD symbol displayed on the right reel 3R substitutes for a 1BAR.

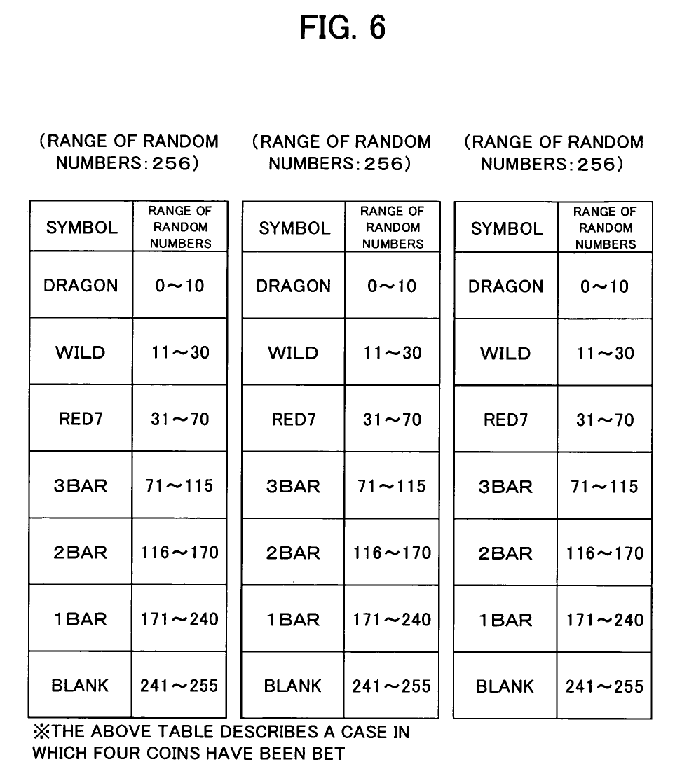

Next, a description will be made regarding a selection probability table for the reels 3L, 3C, and 3R with reference to FIG. 6. In the slot game stage, the symbols displayed along the payline 8 after the rotation of the reels 3L, 3C, and 3R stops are determined with reference to the selection probability table.

FIG. 6 shows the selection probability table for the reels 3L, 3C, and 3R. In cases in which the player has bet four coins, i.e., in a case of the BET number of 4, the symbols to be displayed along the payline 8 after the rotation of the reels 3L, 3C, and 3R stops are determined based upon this table. Note that, while the selection probability tables are also provided for the BET numbers of 1 through 3, detailed description thereof will be omitted.

Each selection probability table shows the relation for each symbol between each range of random numbers and the corresponding symbol to be displayed along the payline 8 after the rotation of the reels 3L, 3C, and 3R stops. A description will be made below regarding a specific method for determining the symbols by a lottery, which are to be displayed along the payline 8 after the rotations of these reels stops. A CPU 121 described later determines which symbols appear on the payline 8 after the reels stop rotating by determining which symbol corresponds to the range of random numbers to which a sampled random number belongs with reference to the selection probability table shown in FIG.6. This random number (integer) has been sampled from a predetermined range of random numbers (for example, a range of numbers between 0 and 255) for each of the reels 3L, 3C, and 3R. Let us say that the sampled random number to be used for determining the symbol to be displayed along the payline 8 after the rotation of the left reel 3L stops is within a range of 116 to 170. In this case, the 2BAR symbol is displayed along the payline 8 after the rotation of the left reels 3L stops.

A description has been made in the present embodiment regarding an arrangement in which the symbol to be displayed along the payline 8 is determined by a lottery for each of the reels 3L, 3C, and 3R. However, the present invention is not restricted to such an arrangement. Also, an arrangement may be made in which the kind of winning is determined by a lottery and the symbols to be displayed along the payline 8 after the rotation of the reels stops are determined based upon the kind of winning thus determined. That is to say, the gaming machine may include winning-type determining device for determining the kind of winning based upon the random number sampled for each round of the game.

Next, a description will be made regarding an overall configuration of a gaming system according to the present embodiment with reference to FIG. 7. FIG. 7 is an explanatory diagram which shows the overall configuration of the gaming system according to the present embodiment. This gaming system comprises multiple gaming machines 1a, 1b, . . . , 1h, and the management server 80. The multiple gaming machines 1a, 1b, 1h, and the management server 80, are connected via communication device (communication line) such as a LAN (local area network) cable or the like, thereby enabling predetermined information to be communicated thereamong. This enables these gaming machines 1 to communicate information to one another under the management of the management server 40. This offers a so-called client/server network with the management server 80 as a server and with the gaming machines 1 as clients.

Next, a description will be made regarding a typical electric circuit of each of the gaming machines 1a, 1b, . . . , 1h forming the aforementioned gaming system with reference to FIG. 8.

FIG. 8 shows a circuit configuration including: a main control circuit 71 for controlling game processing operation of the gaming machine 1; peripheral devices (actuators) electrically connected to the main control circuit 71; and a sub-control circuit 171 for controlling the main display 5 and the second display 6 based upon control instructions transmitted from the main control circuit 71. Note that a CPU 121 of the main control unit 71 is connected to the actuators through an input port and an output port, which are not shown in FIG. 8.

The main control circuit 71 includes a microcomputer 120 disposed on a circuit board, which is a principal component thereof. In addition, the main control circuit 71 includes a circuit having the function of random number sampling. The microcomputer 120 includes a CPU 121 for performing control operation according to a predetermined program, and ROM 122 and RAM 123 which are storage device.

The CPU 121 is connected to a clock pulse generator 124 and a divider 125 for generating a reference clock pulse signal, and to a random number generator 126 and a random number sampling circuit 127 for generating a random number to be sampled. Note that the device for sampling a random number may be attained by executing a random number sampling operation program at the microcomputer 120, i.e., on the CPU 121. Such an arrangement does not necessarily have to include the random number generator 126 and the random number sampling circuit 127. Alternatively, such an arrangement may include the random number generator 126 and the random number sampling circuit 127 as a backup for the random number sampling operation.

The ROM 122 of the microcomputer 120 stores: a program for performing game control of the gaming machine 1; a symbol table with reference to which are determined the symbols to be displayed along the payline 8 after the rotation of all the reels 3L, 3C, and 3R stops; a winning symbol combination table with reference to which the reels 3L, 3C, and 3R are controlled, and with reference to which winning confirmation is made after the rotation of all the reels stops; and a selection probability table with reference to which symbols are determined to be displayed along the payline 8 after the rotation of all the reels 3L, 3C, and 3R stops.

Furthermore, the ROM 122 of the microcomputer 120 stores various kinds of instructions (commands), etc., which are transmitted to the sub-control circuit 171. Examples of these commands include: a demo display command; an all reel stop command; a bonus game start command, for instructing the second display 6 to display an image for a bonus game; etc.

Principal actuators included in the circuit shown in FIG. 8, in which the operation thereof is controlled according to a control signal received from the microcomputer 120, include: stepping electric motors 49L, 49C, and 49R for rotationally driving the reels 3L, 3C, and 3R; a hopper (including a driving unit for discharging coins) for storing coins which serve as a game medium; the main display 5 and the second display 6; various kinds of lamps 60 (error lamp 23, symbol illumination lamp 57, etc.). The stepping electric motors 49L, 49C, and 49R, the hopper 30, the main display 5 and the second display 6, and the various kinds of lamps 60 are connected to the output terminals of the CPU 121 through an electric motor driving circuit 31, a hopper driving circuit 32, the sub-control circuit 171, and a lamp driving circuit 45, respectively. Each of these driving circuits controls the corresponding actuator according to a control signal such as a driving instruction output from the CPU 121.

The sub-control circuit 171, which is for controlling the main display 5 and the second display 5, controls visual effects produced by the main display 5 and the second display 6 according to control instructions (command) from the microcomputer 120. A detailed description will be made later regarding the sub-control circuit 171.

Whereas, a power amplifier 42 serving as an amplifier is connected to the output terminal of the CPU 121 through a sound source IC 41 for controlling the sound to be output from the speaker 43. The sound source IC 41 controls the power amplifier 42 and the speaker 43 according to a control signal such as a control instruction or the like, for output from the CPU 121.

Furthermore, a communication port 128 is provided for enabling the microcomputer 120 to communicate with the server 80 via communication device (a communication line) such as a LAN (local area network) cable (see FIG. 7) or the like.

Examples of principal input signal generating device, each of which is for generating an input signal necessary for allowing the microcomputer 120 to generate a control signal, include: a coin sensor 12S, the error switch 13; the help switch 14; the spin switch 15; the cash out switch 16; the BET switch 17; the maximum BET spin switch 18; the repeat BET switch 19; the cross switch 24; the decision switch 25; a reel position detection circuit 34; a payment completion signal circuit 36; etc. The coin sensor 12S detects a coin inserted via the coin insertion opening 12. The reel position detection circuit 34 supplies signals to the CPU 121 for detecting the positions of the reels 3L, 3C, and 3R, according to pulse signals received from reel position detectors (not shown). The payment completion signal circuit 36 supplies a signal to the CPU 121 for detecting completion of payment of coins, upon the counted value counted by the coin detector 35, which has a function of detecting the coins discharged from the hopper 30, reaching a specified number. The input signal generating device are connected to the input terminals of the CPU 121.

In cases in which the combination of the symbols displayed along the payline 8 matches a particular combination corresponding to a certain winning after the rotation of all the reels stops, the CPU 121 supplies a payment instruction signal to the hopper driving circuit 32, whereupon the hopper 30 discharges a specified number of coins. At this time, the coin detector 35 counts the number of the coins discharged from the hopper 30. Upon the counted number reaching the specified number, the coin detector 35 inputs a coin payment completion signal to the CPU 121. Upon reception of the coin payment completion signal, the CPU 121 stops to drive the hopper 30 through the hopper driving circuit 32, whereupon the “coin payment processing” ends.

Note that the main control circuit 71, the hopper 30, and the hopper driving circuit 32 form the game value providing device. In cases in which the changeable indication device display a combination of symbols matching a particular combination of symbols corresponding to a certain winning after variation thereof is stopped by stop control device, the game value providing device provides a game value to the player.

In the circuit shown in FIG. 8, the random number generator 126 generates a random number in a predetermined range of numbers. The random number sampling circuit 127 samples a random number after a predetermined period of time, upon the spin switch 15, the maximum BET spin switch 18, or the repeat BET spin switch 19 being pressed. Then, the range of the random numbers to which a random number thus sampled belongs is determined with reference to the selection probability table stored in the storage unit within the ROM 122. Then, a reel-stop/symbol signal is generated based upon the symbol corresponding to the range of the random numbers thus determined. Thus, the reels 3L, 3C, and 3R are controlled as described later, and the symbols thus determined are displayed along the payline 8 after the rotation of the reels stops.

After the reels 3L, 3C, and 3R start to rotate, the number of the driving pulses, supplied to each of the stepping electric motors 49L, 49C, and 49R, is counted. The counted numbers are written to a predetermined area in the RAM 123. Each of the reels 3L, 3C, and 3R outputs a reset pulse upon each completed rotation thereof. The reset pulses are input to the CPU 121 through the reel position detection circuit 34. Upon reception of a reset pulse, the CPU 121 resets the driving pulse counted value stored in the RAM 123 to zero. This enables the RAM 123 to store a counted number corresponding to the rotational position within one-revolution for each of the reels 3L, 3C, and 3R.

Furthermore, the ROM 122 stores the symbol table which provides the relation between the rotational position of each of the reels 3L, 3C, and 3R and the corresponding symbol. Specifically, the symbol table provides the relation between the code number and the symbol code which indicates the symbol provided corresponding to the code number. Here, the code number is provided in increments of a predetermined rotational pitch of each of the reels 3L, 3C, and 3R, using the rotational position at which the aforementioned reset pulse is generated as a reference point.

Furthermore, the ROM 122 also stores the winning symbol combination table. The winning symbol combination table provides the relation between the combination of the symbols corresponding to winning, the number of the coins to be paid out for the winning, and the winning determination code which indicates the winning. The winning symbol combination table is referred to when stopping changeable indication operation of the left, center, and right reels 3L, 3C, and 3R, or is referred to when the winning is confirmed after the rotation of all the reels stops.

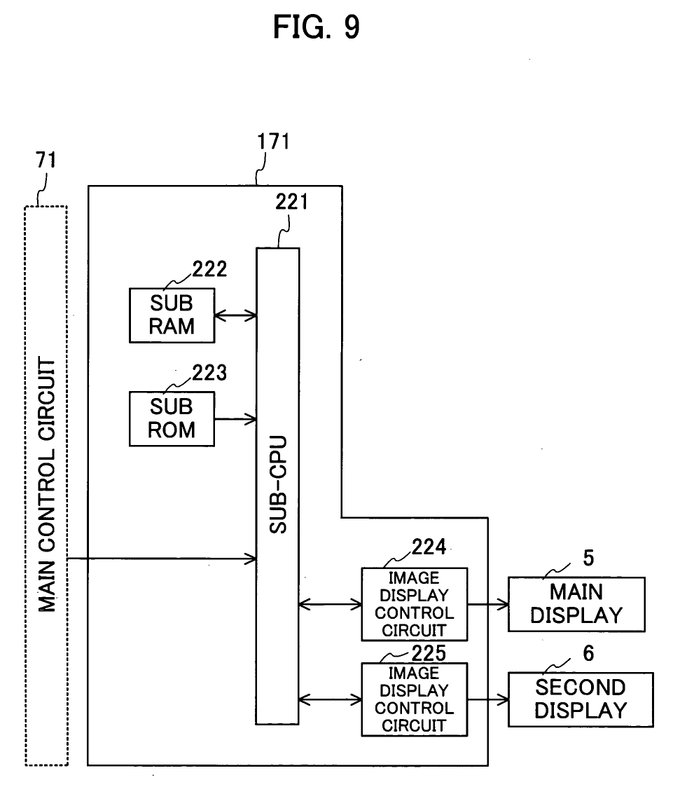

Next, description will be made regarding the sub-control circuit 171 shown in FIG. 9. The sub-control circuit 171 comprises a sub-CPU 221, sub-ROM 222, sub-RAM 223, image display control circuits 224 and 225, etc. Note that INPUT ports or OUTPUT ports are provided between the main control circuit 71 and the sub-control circuit 171, and between the sub-CPU 221 and each actuator, as appropriate.

The sub-CPU 221 determines what images the main display 5 and the second display 6 are to display, based upon the game information command transmitted from the main control circuit 71. Then, the sub-CPU 221 transmits display instructions to the display control circuits 224 and 225.

The sub-ROM 222 stores a communication sequence program for communicating with the main control circuit 71, and a program and data necessary for producing the visual effects for the slot game and for executing the bonus game.

The sub-RAM 223 is used as a work area for executing these control programs.

The image display control circuit 224 includes video RAM (not shown), and controls images displayed on the main display 5. Whereas, the image display control circuit 225 includes video RAM (not shown), and controls images displayed on the second display 6. In particular, the image display control circuit 225 instructs the second display 6 to display images for the bonus game according to a bonus game start command transmitted from the main control circuit 71. A description has been made in the present embodiment regarding an arrangement in which the main control circuit 71 and the sub-control circuit 171 are provided in the form of separate units. Also, an arrangement may be made in which the main control circuit 71 and the sub-control circuit 171 are provided in the form of a single unit.

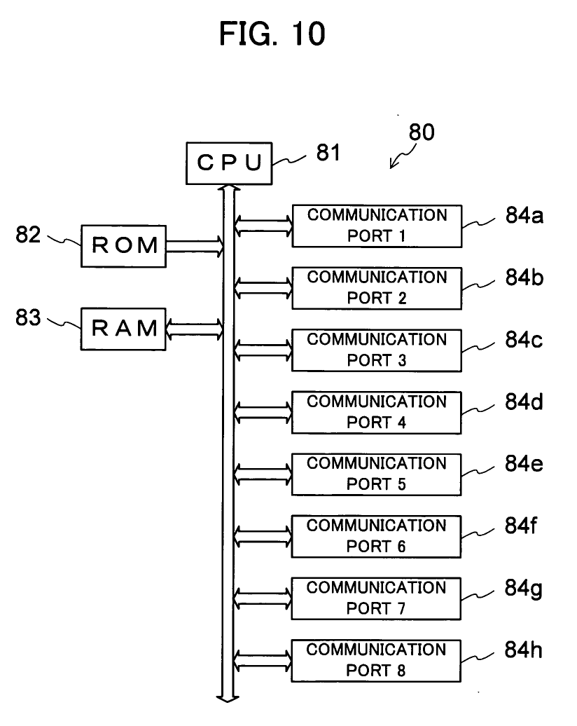

Next, a description will be made regarding the configuration of the management server 80 which is a component of the gaming system according to the present embodiment with reference to FIG. 10. FIG. 10 is a block diagram which shows the configuration of the management server 80. The management server 80 includes a CPU 81, ROM 82, RAM 83, eight communication ports 84a through 84h, etc. The ROM 82 stores a communication control program, and outputs this program to the CPU 81. Whereas, the RAM 83 temporarily stores information or the like transmitted via the communication ports 84a through 85h, and is used as a work memory area for computation processing executed by the CPU 41. The communication ports 84a through 84h are connected to the gaming machines 1a through 1h, respectively. This enables the CPU 81 to identify the gaming machines 1a through 1h using the ID numbers of the communication ports. Note that an arrangement may be made in which a client/server network is established using a single communication port. Such an arrangement requires additional processing for assigning IDs to the gaming machines 1a through 1h in order to allow the CPU 81 to identify the gaming machines.

The information transmitted from each gaming machine 1 is temporarily transmitted to the management server 80. In cases in which the information thus received includes information regarding the destination, the management server 80 identifies the destination, and outputs the received information through the communication port 84 connected to the gaming machine 1 specified by the destination thus identified. This provides two-way data communication among the gaming machines 1.

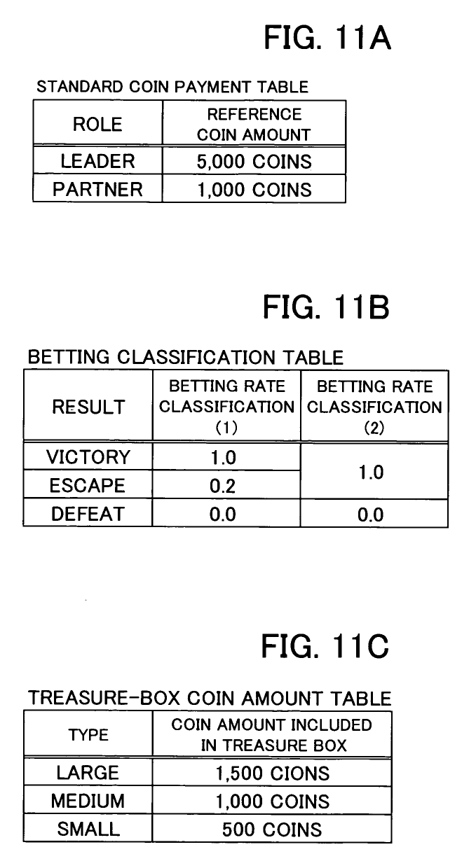

Next, description will be made regarding a bonus game coin acquisition computation expression, a standard coin payment table, a betting classification table, and a treasure-box coin amount table, with reference to FIG. 11A, FIG. 11B, and FIG. 11C.
COIN PAYMENT AMOUNT=(STANDARD COIN PAYMENT AMOUNT×BETTING RATE CLASSIFICATION (1))+{(COIN AMOUNT INCLUDED IN TREASURE BOX/NUMBER OF GAMING MACHINES WHERE BONUS GAME IS BEING EXECUTED)×BETTING RATE CLASSIFICATION (2)} [Expression 1]

The computation expression represented by Expression 1 is an expression for calculating the number of coins to be paid out in the bonus game stage, which is stored in the ROM 82 included in the management server 80. The number of coins to be paid out after the bonus game is computed using this coin payment amount computation expression for the gaming machines where the bonus game is executed. As represented by the computation expression for calculating the number of coins to be paid out, the number of coins to be paid out is determined by the standard coin payment amount, the betting rate classification (1), the betting rate classification (2), the number of coins in the treasure box, and the number of gaming machines where the bonus game is executed.

The table shown in FIG. 11A is a standard coin payment table, which is referred to for computing the number of coins to be paid out. The standard coin payment table is stored in the ROM 82 included in the management server 80. As shown in the standard coin payment table, the standard coin payment amount is determined based upon the role of the allied character in the battle game executed in the bonus game stage. The standard coin payment amount is a coefficient of the coin payment amount computation expression. Accordingly, the coin payment amount is variable corresponding to the role of the allied character in the battle game executed in the bonus game stage. Here, the term “allied character” as used here represents a character in a battle game, which is played by the player at each of the gaming machines 1a through 1h. In the battle game stage, the allied characters battle a dragon in cooperation with one another.

The allied character roles in the battle game are classified into two roles, i.e., “leader” and “partner”. The “leader” is the allied character role which is played by the player at the gaming machine (1a, for example) where three dragons are displayed along the payline after the rotation of all the reels 3L, 3C, and 3R stops in the slot game stage, i.e., the gaming machine where the player has initiated a bonus game. The term “partner” as used here represents the allied character role which is played by the player who participates in a battle game initiated by another gaming machine.

In the battle game, in cases in which the player plays the leader allied character role, the standard coin payment amount is set to 5,000. Whereas, in cases in which the player plays the partner allied character role, the standard coin payment amount is set to 1,000.

Next, description will be made regarding the betting classification table shown in FIG. 11B. The betting classification table is a table which is referred to in computing the number of coins to be paid out, in the same way as with the standard coin payment table. The betting classification table is also stored in the ROM 82 included in the management server 80. As shown in the betting classification table, the betting rate classification (1) and the betting rate classification (2) are changed corresponding to the results of the battle game executed in the bonus game stage (which will be referred to as “result of the bonus game” hereafter). The betting rate classification (1) and the betting rate classification (2) are used as the coefficients of the computation expression for computing the number of coins to be paid out. This means that the number of coins to be paid out is variable corresponding to the results of the bonus game.

The results of the bonus game are classified into three types, i.e., “victory”, “escape”, and “defeat”. “Victory” represents a result in which the allied characters have destroyed the dragon which is an enemy character, i.e., have won a victory over the enemy character (have succeeded in reducing the HP of the enemy character to zero). In a case of “victory”, both the betting rate classification (1) and the betting rate classification (2) are set to 1.0. “Escape” represents the result in which the players have escaped from the battle stage without destroying the dragon which is an enemy character. In cases in which the player who is playing the leader role has selected “escape” command, the result is set to “escape”. In a case of “escape”, the betting rate classification (1) is set to 0.2, and the betting rate classification (2) is set to 1.0. In cases in which all the allied characters have died before destroying the dragon which is an enemy character, the result is set to “defeat”. As described later, in cases in which the hit points (which will be referred to as “HP” hereafter) of an allied character are reduced to zero, the allied character dies. In a case of “defeat”, both the betting rate classification (1) and the betting rate classification (2) are set to 0.0.

Next, a description will be made regarding the treasure-box coin amount table shown in FIG. 11C. The treasure-box coin amount table is a table which is referred to for computing the number of coins to be paid out in the same way as with the standard coin payment table. The treasure-box coin amount table is also stored in the ROM 82 included in the management server 80. As shown in the treasure-box coin amount table, the treasure-box coin amount is variable corresponding to the size of the treasure box acquired from the enemy character after the battle game. The treasure-box coin amount is used as a parameter of the computation expression for computing the number of coins to be paid out. Accordingly, the number of coins to be paid out is variable corresponding to the size of the treasure box.

The size of the treasure box is classified into three sizes, i.e., “large”, “medium”, and “small”. The “large” treasure box includes 1,500 coins. The “medium” treasure box includes 1,000 coins. The “small” treasure box includes 500 coins.

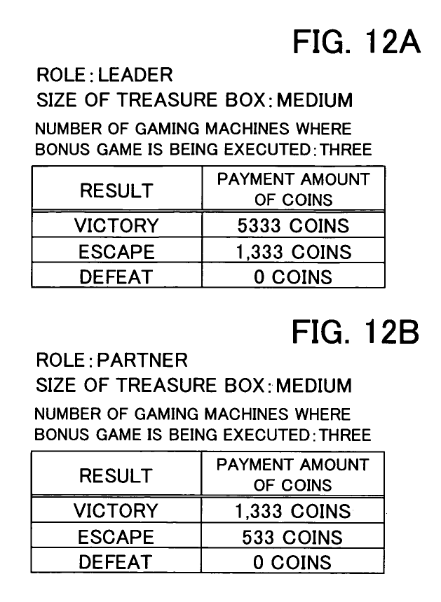

Next, a description will be made regarding a specific calculation of the number of coins to be paid out, with reference to FIG. 12A and FIG. 12B. FIG. 12A shows the number of coins to be paid out in cases in which the player plays the leader allied character role in the battle game stage, the size of the treasure box is “medium”, and the bonus game is being executed in three gaming machines. As can be clearly understood from FIG. 12A, the number of coins to be paid out is highly variable corresponding to the result of the bonus game.

As described above, the number of coins to be paid out varies corresponding to the result of the battle game. This means that the result of the special game stage, i.e., the number of the coins to be paid out, is affected by the actions of the allied characters, e.g., each of the commands such as “attack”, “magic”, “escape”, etc. This increases the player's level of interest with respect to strategy, e.g., what command the player should select, thereby improving the amusement value of the game.

FIG. 12B shows the number of coins to be paid out in cases in which the player plays the partner allied character role in the battle game stage, the size of the treasure box is “medium”, and the bonus game is being executed in three gaming machines. Making a comparison between FIG. 12A and FIG. 12B, there is a great difference in the number of coins to be paid out. The difference in the number of coins to be paid out is due to the variations in the role of the allied character in the battle game.

In such an arrangement, there is a difference in the number of coins to be paid out, between the player of the gaming machine 1, where the three dragons have been displayed along the payline after the rotation of all the reels 3L, 3C, and 3R stops in the slot game stage, and other players at other gaming machines who have participated in the battle game initiated by the former player. This ensures fairness among the players.

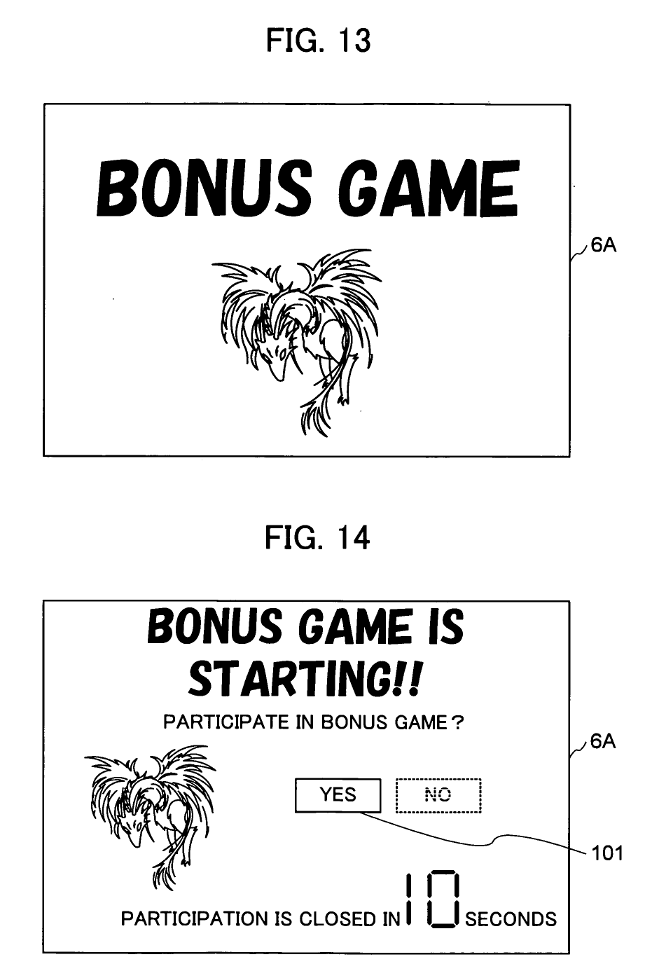

Next, a description will be made regarding the bonus game executed by the gaming system 100 with reference to FIG. 13 through FIG. 27.

As described above, in cases in which the three dragons are displayed along the payline 8 after the rotation of all the reels 3L, 3C, and 3R stops in the slot game stage, the game stage is switched from the slot game stage to the bonus game stage, whereupon the bonus game is executed. Furthermore, in cases in which at least one machine among the gaming machines 1a through 1h enters the bonus game stage, the gaming machines 1a through 1h (see FIG. 7), which are connected with each other via communication device (communication line) such as a LAN (local area network) or the like, also enter a stage which allows the bonus game to be executed.

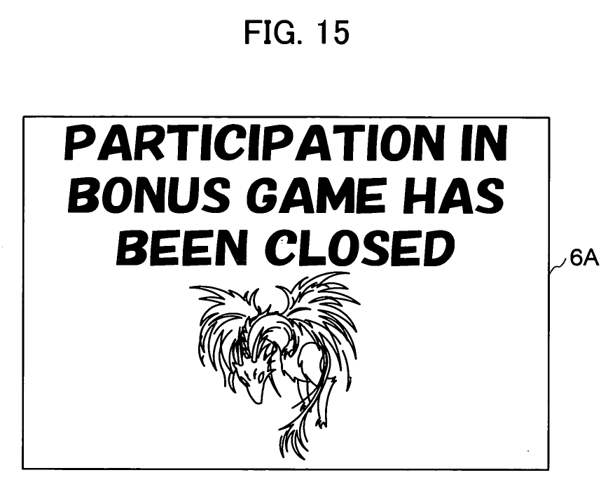

Let us say that one machine (gaming machine 1a, for example) among the gaming machines 1a through 1h enters the bonus game stage as a result of the three dragons being displayed along the payline 8 after the rotation of all the reels 3L, 3C, and 3R stops in the slot game stage. In this case, the image shown in FIG. 13 is displayed on a screen 6A (see FIG. 1) of the second display 6 of the gaming machine 1a. At the same time, the image shown in FIG. 14 is displayed on the screen 6A of the second display 6 of the other gaming machines 1b, . . . , 1h. The image shown in FIG. 14 is displayed in order to invite other players to participate in the bonus game. In cases in which a player wants to participate in the bonus game, the player operates the cross switch 24 (see FIG. 1) so as to select “YES” 101, and presses the decision switch 25 (see FIG. 1). Note that the option of participating in the game is restricted to within a predetermined time limit (under the arrangement shown in FIG. 14, the time limit is set to ten seconds). After the time limit, the player cannot participate in the bonus game, and the image shown in FIG. 15 is displayed. Furthermore, the option of participating in the game is restricted by a predetermined quota limit. Also, in cases in which the number of the players participating in the bonus game has exceeded the quota limit, the image shown in FIG. 15 is displayed on the screen 6A of the second display 6.

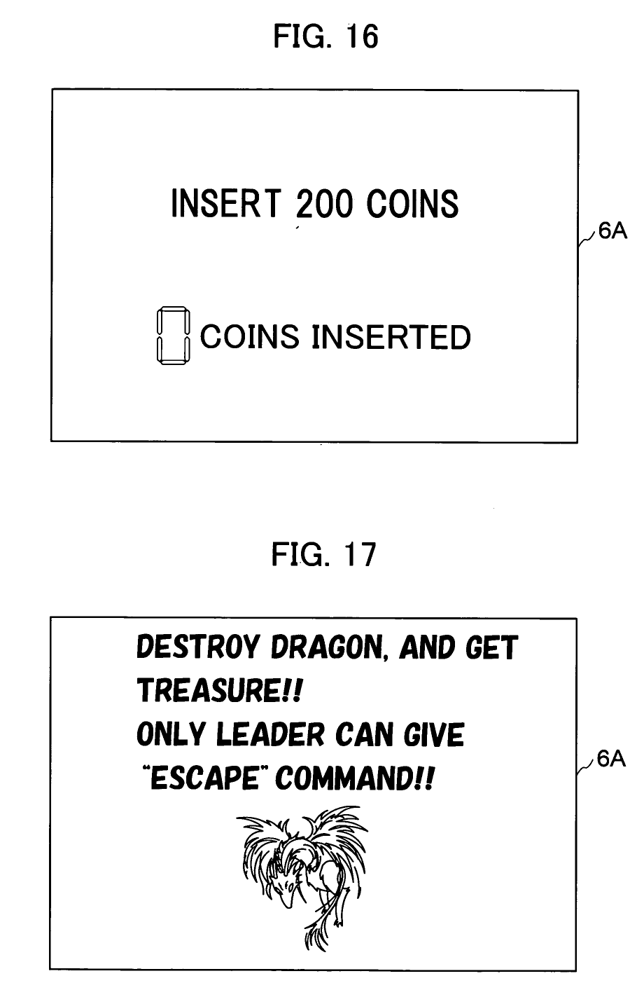

In cases in which a player selects to participate in the bonus game, the player needs to insert two hundreds coins as an ante. The image shown in FIG. 16 is displayed on the screen 6A of the second display 6 of each of the gaming machines 1b, . . . , 1h, in order to instruct the players to insert the ante.

The image shown in FIG. 17 is displayed on the screen 6A of the second display 6 of each of the gaming machines participating in the bonus game (gaming machines 1a, 1b, and 1c, for example), in order to describe the rules of the battle game.

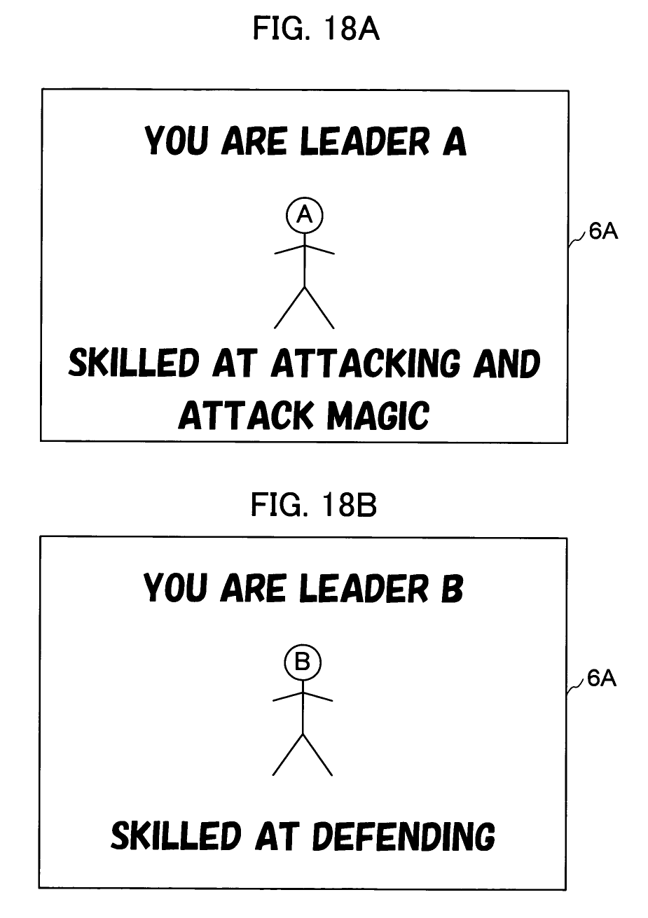

After display of the image shown in FIG. 17, the image as shown in FIG. 18A is displayed on the screen 6A of the second display 6 of the gaming machine 1a where the player has initiated a bonus game. Whereas, the image as shown in FIG. 18B (provided for exemplary purposes only) is displayed on the screen 6A of the second display 6 of each of the gaming machines (1a, 1b, 1c) where the players are participating in the bonus game. FIGS. 18A and 18B show an example of the images for describing the role and attributes of the allied character which is to be played by the player participating in the battle game. Specifically, FIG. 18A shows the image which is displayed on the gaming machine 1a for describing the role of the character A, i.e., the leader, and the attributes of the character A, i.e., that the character A is skilled at attacking and attack magic. FIG. 18B shows the image which is displayed on the other gaming machines (e.g., gaming machine 1b) for describing the role of the character B, i.e., the partner, and the attributes of the character B, i.e., that the character B is skilled at defending.

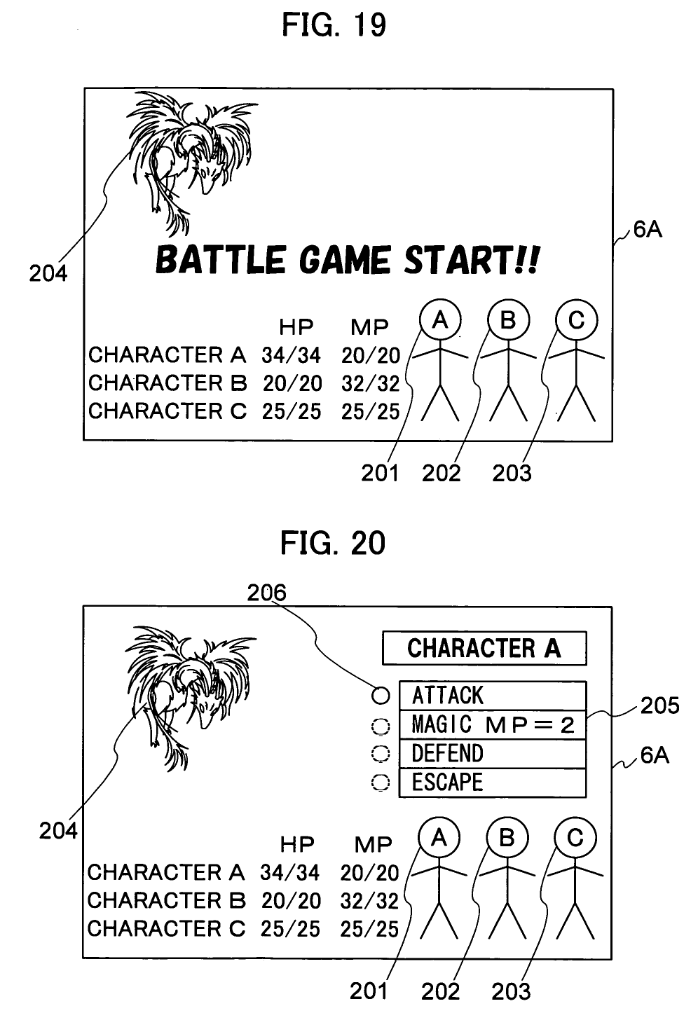

After display of the images shown in FIG. 18, the image shown in FIG. 19 is displayed on the screen 6A of the second display 6 of each of the gaming machines 1a, 1b, and 1c where the players are participating in the bonus game. FIG. 19 shows an image for notifying the players of the beginning of the battle game. Specifically, the image shown in FIG. 19 includes a character A201, character B202, and character C203, which are allied characters, and a dragon which is an enemy character 204. Furthermore, the “HP” and “MP” values are displayed in the image shown in FIG. 19. Here, “HP” represents the “hit points”. The HP of each allied character are reduced due to the attack and the attack magic received from the enemy character 204. In cases in which the HP are reduced to zero, the allied character dies. Whereas, “MP” represents the “magic points”. The allied character can use magic until the magic points are reduced to zero.

FIG. 20 shows a “command selecting image” which allows the action of the allied character to be selected. The “command selecting image” includes a command menu 205 having several kinds of commands for allowing the action of the character A201 to be selected. Specifically, the command menu 205 includes the commands of “attack”, “magic”, “defend”, and “escape”. The player can turn on the circle mark 206 adjacent to the command to be selected, by pressing the upper or lower portion of the cross switch 24. Subsequently, upon the decision switch 25 being pressed twice, the command adjacent to the circle mark 206 thus turned on is set to be the next action of the character A. Note that the indication “MP=2” adjacent to “magic” represents that the “MP” is reduced by 2 for each selection of magic.

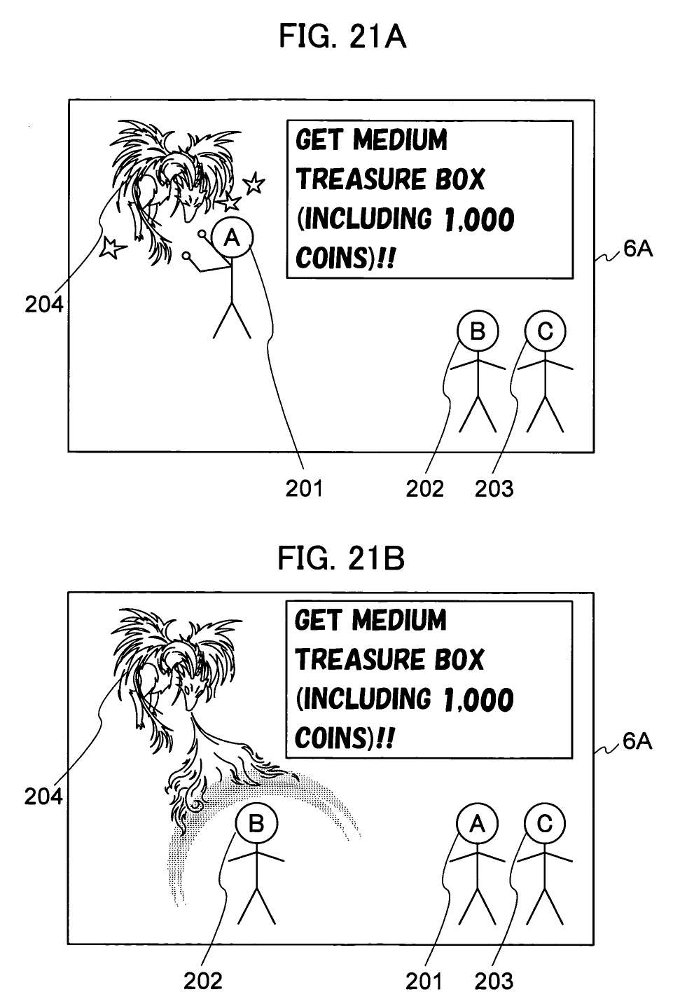

Upon selecting the action of the character, the image of the character with the action corresponding to the selected command is displayed on the screen 6A of the second display 6 of the gaming machine 1. FIGS. 21A and 21B show an image in which the character A201 is attacking the dragon which is the enemy character 204 as a result of selecting the action “attack”, and an image in which the allied characters are effectively defending themselves against an attack from the dragon as a result of selecting the action “defend”, respectively. Furthermore, the indication “get medium treasure box (1,000 coins)” is displayed in the images shown in FIGS. 21A and 21B. This indicates that the players have acquired a treasure box including 1,000 coins as a result of their attack on the enemy character 204 or their defense against an attack from the enemy character 204.

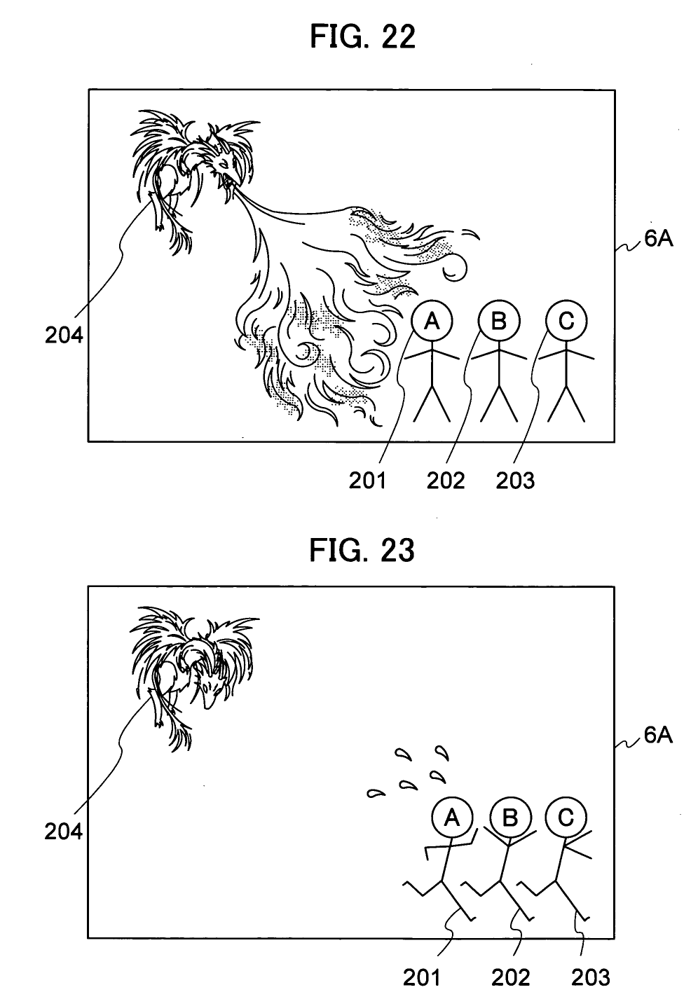

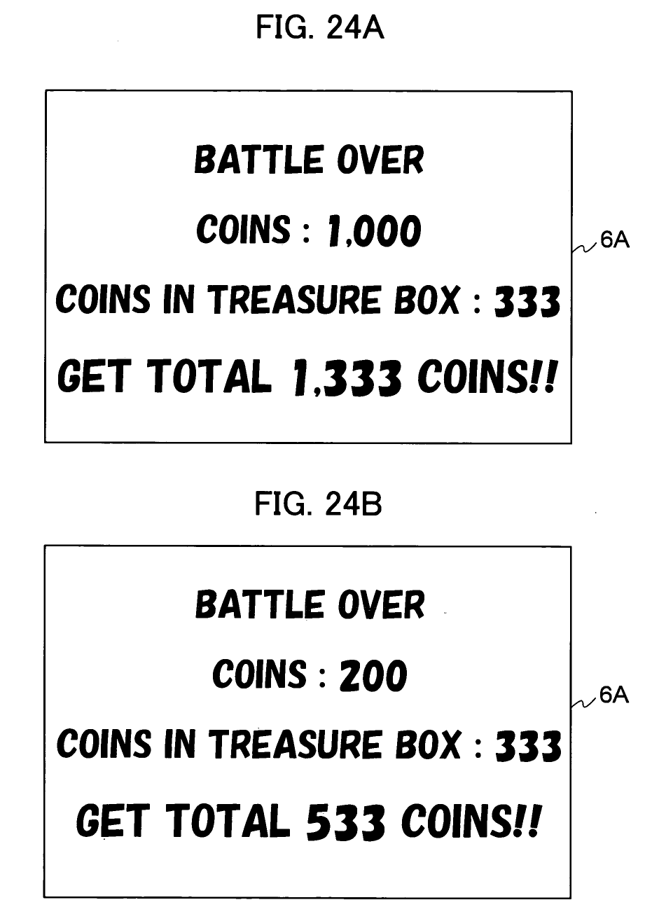

In contrast with FIGS. 21A and 21B, FIG. 22 shows an image in which the character A201, the character B202, and the character C203 are being attacked by the enemy character 204. In cases in which the allied character is attacked by the enemy character 204, the aforementioned “HP” are reduced.

Whereas, FIG. 23 shows an image in which the character A201, the character B202, and the character C203 are escaping as a result of the character A201 selecting the action “escape”. The command “escape” can only be selected by the lead character. In cases in which “escape” command has been selected, the battle game ends, whereupon the image as shown in FIG. 24A is displayed on the screen 6A of the second display 6 of the gaming machine 1a.

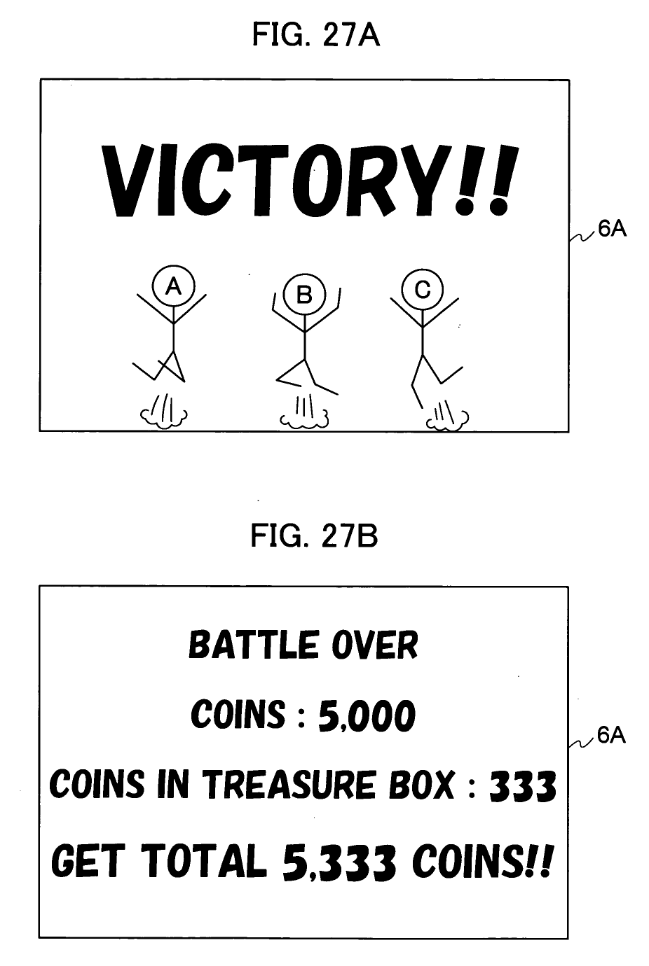

FIG. 24A shows an example of an image which provides notification that the battle game has ended. The image is displayed in cases in which the allied characters have destroyed the enemy character, i.e., have won a victory over the enemy character (i.e., have succeeded in reducing the HP of the enemy character to zero), or in cases in which “escape” command has been selected. Specifically, in cases in which the allied characters have won a victory over the enemy character, this image is displayed on the screen 6A of the second display 6 of the gaming machine 1b where the player has participated in the battle game as a partner. Subsequently, 1,333 coins are paid out from the gaming machine 1b on which this image has been displayed. Whereas, 5,333 coins are paid out to the gaming machine 1a where the player has played the leader (see FIG. 27B).

Note that, in cases in which “escape” has been selected, 1,333 coins are paid out to the gaming machine 1a where the player has played the leader (see FIG. 24A). Whereas, 533 coins are paid out to the gaming machine 1a where the player has played the partner (see FIG. 24B).

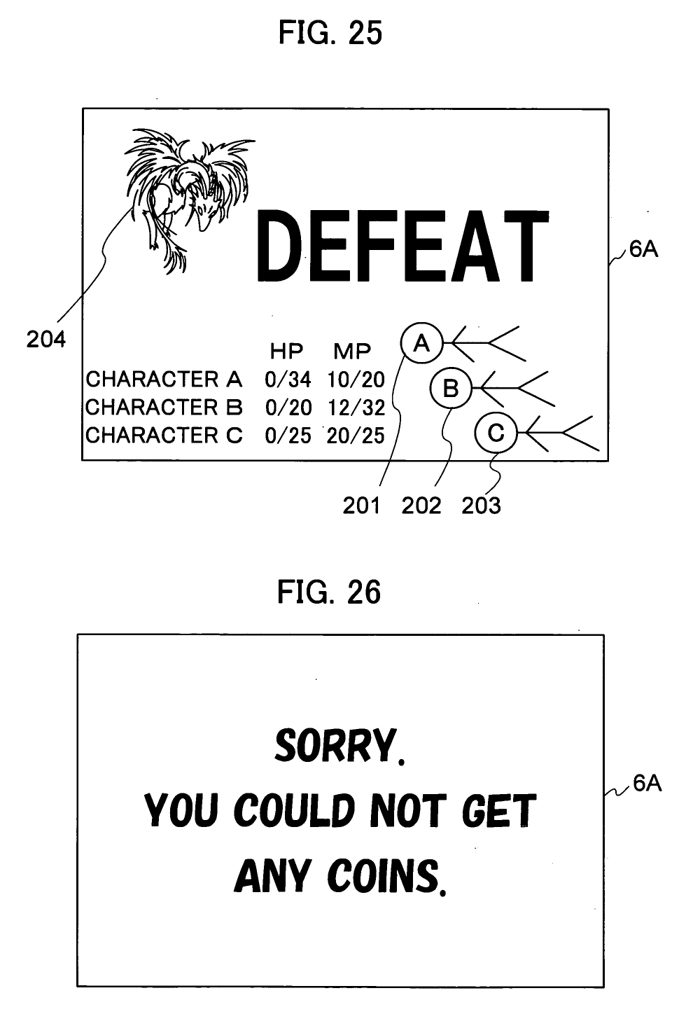

Furthermore, in cases in which the HP of all the allied characters are reduced to zero, i.e., in cases in which the character A201, the character B202, and the character C203 have died, the image shown in FIG. 25 is displayed on the screen 6A of the second display 6 of each of the gaming machines 1. After the image shown in FIG. 25 is displayed, the image as shown in FIG. 26 is displayed on the screen 6A of the second display 6 of each of the gaming machines 1, which notified that the battle game has ended. As shown in the image in FIG. 26, in cases in which the “HP” of all the allied characters have been reduced to zero, the number of coins to be paid out is set to zero.

However, in cases in which the allied characters have destroyed the enemy character, i.e., have won a victory over the enemy character (i.e., have succeeded in reducing the HP of the enemy character to zero), the image as shown in FIG. 27A is displayed on the screen 6A of the second display 6 of each of the gaming machines 1a, 1b, and 1c. FIG. 27A shows an image which depicts the allied characters celebrating a victory over the enemy character. In cases in which the allied characters have won a victory over the enemy character, the image as shown in FIG. 27B or FIG. 24A is displayed on the screen 6A of the second display 6 of each of the gaming machines 1a, 1b, and 1c. Subsequently, the bonus game in the form of a battle game ends, and each gaming machine provides the slot game again.

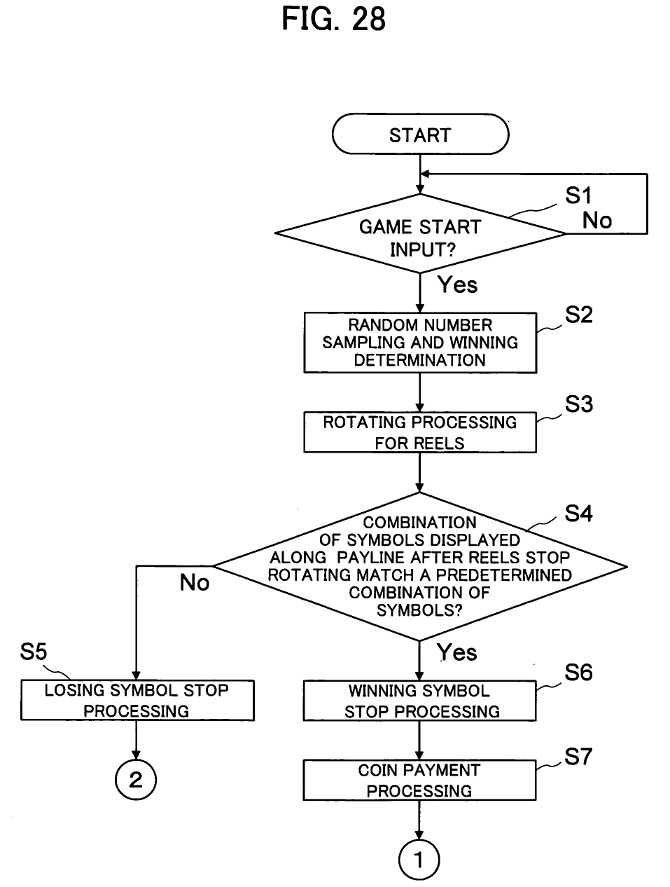

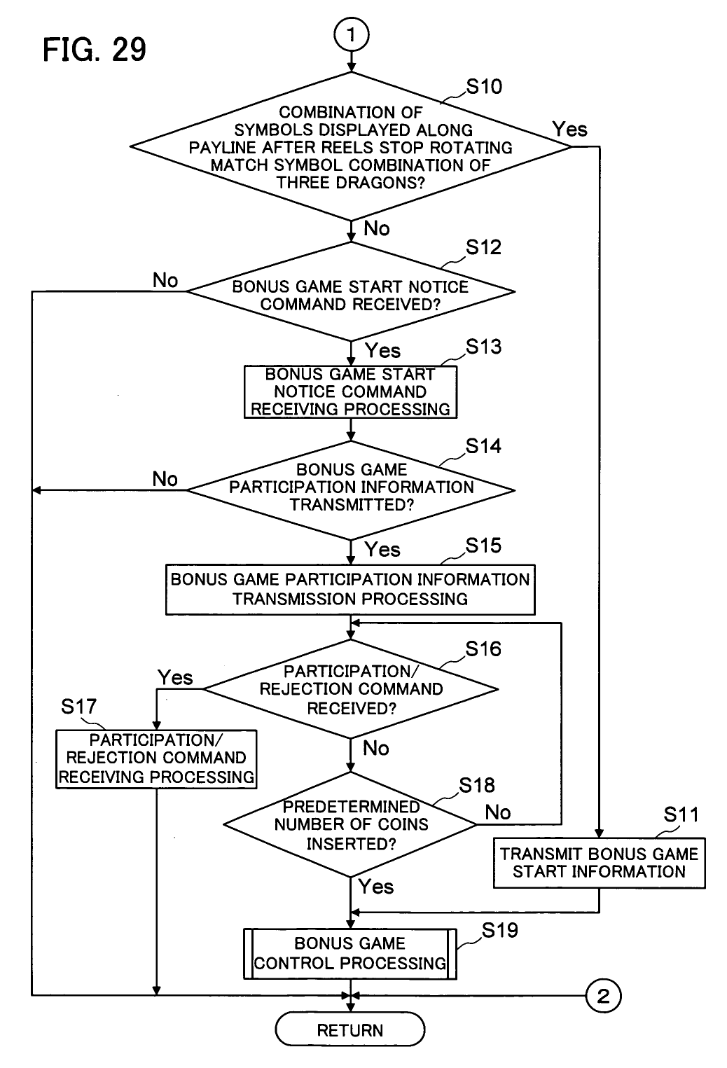

Next, a description will be made regarding the outline of the control operation of the CPU 121 of the main control circuit 71 of the gaming machine 1 with reference to the flowcharts shown in FIG. 28 and FIG. 29.

As shown in FIG. 28, the CPU 121 determines whether or not the game start signal has been input (Step S1). In this step, the CPU 121 determines whether or not a start signal has been input from any one of the spin switch 15, the maximum BET spin switch 18, and the repeat BET spin switch 19.

In cases in which determination has been made that no start signal has been input from the spin switch 15, the maximum BET spin switch 18, or the repeat BET spin switch 19, in the Step S1, the CPU 121 repeats the processing in Step S1.

In cases in which determination has been made that the start signal has been input from the spin switch 15, the maximum BET spin switch 18, or the repeat BET spin switch 19, in the Step S1, the CPU 121 executes random number sampling and winning determination processing (Step S2). In the random number sampling processing, the CPU 121 generates a signal so as to instruct the random number generator 126 to generate a random number, and instructs the random number sampling circuit 127 to sample a random number for each of the three reels 3L, 3C, and 3R. Subsequently, the CPU 121 stores the values of the random numbers thus sampled, in a predetermined region of the RAM 123. Subsequently, in the winning determination processing, for each of the three reels 3L, 3C, and 3R, the CPU 121 determines the range of random numbers to which the random number stored in the RAM 123 belongs, based upon the selection probability table shown in FIG. 6 which is stored in the ROM 122 beforehand. Thus, the CPU 121 determines the symbols to be displayed along the payline 8 after the rotation of the reels stops, and stores the symbols in the RAM 123. Next, the CPU 121 determines the winning corresponding to these symbols to be displayed after the rotation of the reels stops, based upon the winning symbol combination table stored in the ROM 122 beforehand. Following this processing, the flow proceeds to Step S3.

Afterwards, the CPU 121 executes rotation processing for the reels 3L, 3C, and 3R (Step S3). In this step, the CPU 121 transmits a driving signal to the electric motor driving circuit 31 so as to rotationally drive the reels 3L, 3C, and 3R. Following this processing step, the flow proceeds to Step S4.

Next, the CPU 121 determines whether or not the combination of the symbols, which are to be displayed along the payline 8 after the rotation of all the reels 3L, 3C, and 3R stops, matches any one of the predetermined combinations as shown in FIG. 5 (Step S4).

In cases in which determination has been made that the combination of the symbols, which are to be displayed along the payline 8 after the rotation of all the reels 3L, 3C, and 3R stops, does not match any one of the predetermined combinations in Step S4 (e.g., in a case of the symbol combination such as “WILD—red 7 —1BAR”, which is not shown in FIG. 5), the CPU 121 executes losing symbol stop processing (Step S5). In this processing step, the CPU 121 transmits a signal to the electric motor driving circuit 31 so as to control this circuit such that the rotation of the reels 3L, 3C, and 3R stops, corresponding to the stop symbols determined by the processing in Step S3. Subsequently, the electric motor driving circuit 31 controls the reels 3L, 3C, and 3R such that the combination of the symbols to be displayed along the payline 8 after the rotation of all the reels 3L, 3C, and 3R stops does not match any one of the predetermined combinations as shown in FIG. 5. Following this processing step, the flow returns to Step S1.

In cases in which determination has been made that the combination of the symbols, which are to be displayed along the payline 8 after the rotation of all the reels 3L, 3C, and 3R stops, matches any one of the predetermined combinations as shown in FIG. 5 in Step S4, the CPU 121 executes winning symbol stop processing (Step S6). In this processing step, the CPU 121 transmits a signal to the electric motor driving circuit 31 so as to control this circuit such that the rotation of the reels 3L, 3C, and 3R stops, corresponding to the stop symbols determined by the processing in Step S3. Subsequently, the electric motor driving circuit 31 controls the reels 3L, 3C, and 3R such that the combination of the symbols to be displayed along the payline 8 after the rotation of all the reels 3L, 3C, and 3R stops matches the determined one of the combinations as shown in FIG. 5. Following this processing step, the flow returns to Step S7.

Then, the CPU 121 executes coin payment processing (Step S7). In this processing, the CPU 121 supplies a coin payment signal to the hopper driving circuit 32 corresponding to the kind of winning. This instructs the hopper 30 to pay out a predetermined number of coins. Following this processing step, the flow proceeds to Step S10 shown in FIG. 29.

Next, as shown in FIG. 29, the CPU 121 determines whether or not the combination of the symbols displayed along the payline 8 after the rotation of the reels 3L, 3C, and 3R stops, matches a particular symbol of three dragons (Step S10).

In cases in which determination has been made that the combination of the symbols displayed along the payline 8 after the rotation of the reels 3L, 3C, and 3R stops, matches the particular combination of three dragon symbols in Step S10, the CPU 121 transmits a bonus game start notice command (special game information) to the management server 80 (Step S11). Following this processing, the flow proceeds to Step S19.

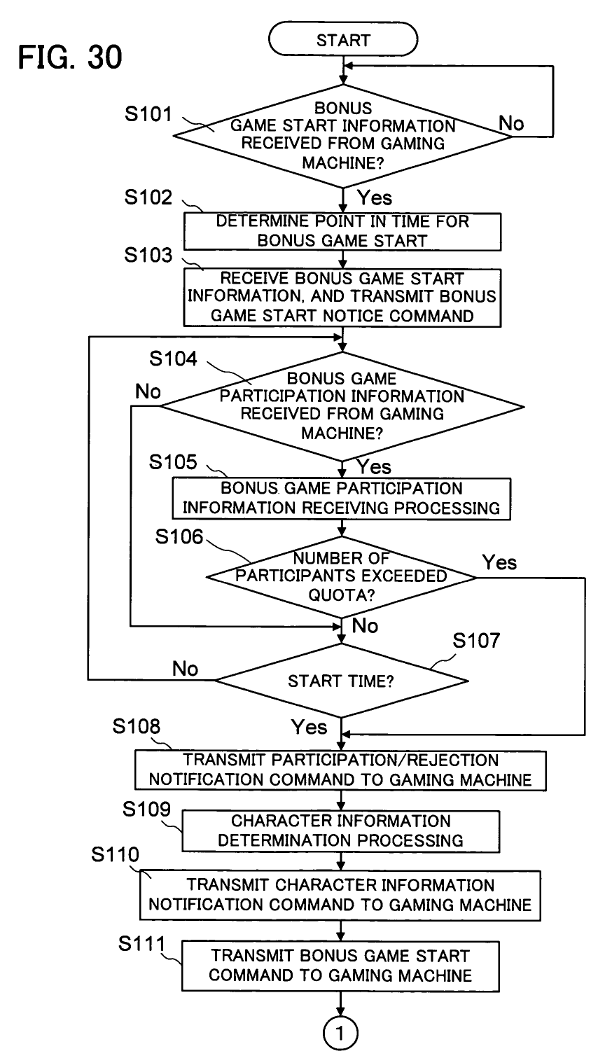

In cases in which determination has been made that the combination of the symbols displayed along the payline 8 after the rotation of the reels 3L, 3C, and 3R stops, does not match the particular symbol of three dragons in Step S10, the CPU 121 determines whether or not the gaming machine has received a bonus game start notice command (special game participation selection information) transmitted from the management server 80 (Step S12). In this processing step, the CPU 121 determines whether or not the gaming machine has received the bonus game start notice command transmitted in the processing step (Step S102 in FIG. 30) performed by the management server 80. The term “bonus game start notice command” as used here represents information which provides a notice that a bonus game has been initiated by one of the other players.

In cases in which determination has been made that the gaming machine has not received the bonus game start notice command from the management server 80 in Step S12, the flow returns to Step S1 shown in FIG. 28. Whereas, in cases in which determination has been made that the gaming machine has received the bonus game start notice command from the management server 80, the CPU 121 executes bonus game start notice command reception processing (Step S13). In this processing, the CPU 121 receives the bonus game start notice command, and transmits a signal to the sub-control circuit 171 for displaying the image shown in FIG. 14 on the screen 6A of the second display 6. Following this processing step, the flow proceeds to Step S14.

Subsequently, the CPU 121 determines whether or not bonus game participation information (special game participation information) is to be transmitted to the management server 80 (Step S14). The term “bonus game participation information” as used here represents the information which provides notification that the player is to participate in the bonus game. Note that the bonus game participation information is transmitted from a different gaming machine from of which one of the other players has initiated the bonus game.

In cases in which determination has been made that the bonus game participation information is not to be transmitted to the management server 80 in Step S14, the flow returns to Step S1 shown in FIG. 28. Whereas, in cases in which determination has been made that the bonus game participation information is to be transmitted to the management server 80, the CPU 121 executes bonus game participation information transmission processing (Step S15). In this processing step, the CPU 121 transmits the bonus game participation information to the management server 80. Following this processing step, the flow proceeds to Step S16.

Afterwards, the CPU 121 determines whether or not the gaming machine has received a command that rejects an offer to participate in a bonus game (which will be referred to as “participation rejection command” hereafter) from the management server 80 (Step S16). In this processing step, the CPU 121 determines whether or not the gaming machine has received the participation rejection command transmitted in the processing executed by the management server 80 (Step S108 in FIG. 30). The term “participation rejection command” as used here represents the information for instructing the gaming machines 1b through 1h to display the information that the players cannot participate in the bonus game or the image shown in FIG. 15 on the screen 6A (see FIG. 1) of the second display 6 thereof, because the participation list has been closed.

In cases in which determination has been made that the gaming machine has received the participation rejection command from the management server 80 in Step S16, the CPU 121 executes participation rejection command reception processing (Step S17). In this processing step, the CPU 121 receives the participation rejection command, and transmits a signal to the sub-control circuit 171 for displaying the image shown in FIG. 15 on the screen 6A of the second display 6. Following this processing step, the flow returns to Step S1 shown in FIG. 28.

In cases in which the determination has been made that the gaming machine has not received the participation rejection command from the management server 80 in Step S16, the CPU 121 determines whether or not a predetermined number of coins required for participation in the bonus game have been inserted (Step S18).

In cases in which determination has been made that the predetermined number of coins required for participation in the bonus game have not been inserted in the processing in Step S18, the flow returns to Step S16. Whereas, in cases in which determination has been made that the predetermined number of coins required for participation in the bonus game have been inserted, the flow proceeds to Step S19.

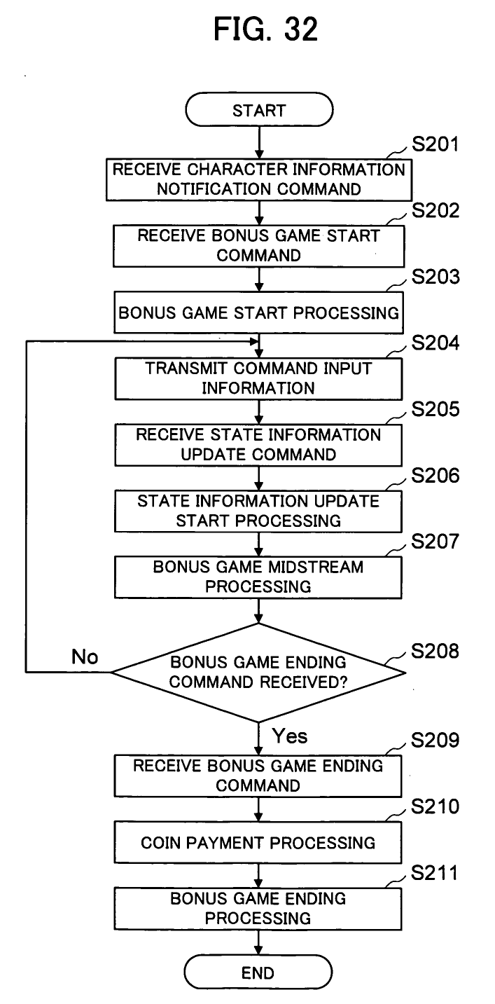

Next, the CPU 121 executes (gaming machine side) bonus game control processing (Step S19), which will be described with reference to FIG. 32. Following this processing, the flow proceeds to Step S1 shown in FIG. 28.

A description has been made in the present embodiment regarding an arrangement in which the winning determination processing (Step S2), the symbol stop processing step (Steps S5, and S6), and the coin payment processing (Step S7) are executed after the symbols to be displayed after the rotation of the reels stops are determined by random number sampling. However, the present invention is not restricted to such an arrangement. For example, an arrangement may be made in which the symbol stop processing step and the winning determination processing step are executed after the symbols to be displayed after the rotation of the reels stops are determined by random number sampling. With such an arrangement, in this winning determination processing, in cases in which the player has won the winning, the gaming machine performs coin payment processing step (corresponding to Step S7). Whereas, in cases in which the player has not won, the gaming machine does not perform the coin payment processing step.

Next, a description will be made regarding management server side bonus game control processing with reference to FIG. 30. The term “server side bonus game control processing” as used here represents the processing executed by the management server 80 in the bonus game stage.

First, as shown in FIG. 30, the management server 80 determines whether or not the management server 80 has received the bonus game start information from the gaming machines 1 (Step S101). In this processing step, the management server 80 determines whether or not the management server 80 has received the bonus game start information transmitted in the processing (Step S11 shown in FIG. 29) executed by the gaming machines 1.

In cases in which determination has been made that the management server 80 has not received the bonus game start information from the gaming machine 1a in Step S101, the processing in Step S101 is repeatedly performed. Whereas, in cases in which determination has been made that the management server 80 has received the bonus game start information from the gaming machine 1, the management server 80 determines the point in time of the start of the bonus game (Step S102). Following this processing step, the flow proceeds to Step S103.

Afterwards, the management server 80 receives the bonus game start information from the gaming machine 1a, and transmits the bonus game start notice command to the gaming machines (Step S103). In this case, the recipients of this command-are all the gaming machines 1b through 1h, except for the gaming machine where the player has initiated a bonus game. Following this processing step, the flow proceeds to Step S104.

Next, the management server 80 determines whether or not the management server 80 has received the bonus game participation information from each of the gaming machines 1b through 1h (Step S104). In this processing step, the management server 80 determines whether or not the management server 80 has received the bonus game participation information transmitted in the processing executed by the gaming machine 1a (Step S15 in FIG. 29).

In cases in which determination has been made that the management server 80 has not received the bonus game participation information from the gaming machines 1b through 1h in the processing in Step S104, the flow proceeds to Step S107. Whereas, in cases in which determination has been made that the management server 80 has received the bonus game participation information from the gaming machines 1b through 1h, the management server 80 executes bonus game participation information reception processing (Step S105). Following this processing step, the flow proceeds to Step S106.

Afterwards, the management server 80 determines whether or not the number of the gaming machines which are to participate in the bonus game has exceeded a predetermined quota (Step S106). In this processing step, the management server 80 determines whether or not the number of rounds of bonus game participation information reception in Step S105 has exceeded a predetermined number.

In cases in which determination has been made that the number of the gaming machines which are to participate in the bonus game has exceeded the predetermined quota in Step S106, the flow proceeds to Step S108. Whereas, in cases in which determination has been made that the number of the gaming machines which are to participate in the bonus game has not exceeded the predetermined quota, the management server 80 determines whether or not the point in time has reached at which the bonus game is to be started (Step S107).

In cases in which determination has been made that the point in time at which the bonus game is to be started has not yet been reached, the flow returns to Step S104. Whereas, in cases in which determination has been made that the point in time at which the bonus game is to be started has been reached, the management server 80 transmits the participation rejection command to the gaming machine 1b through 1h (Step S108). Note that in cases in which a gaming machine has transmitted the bonus game participation information after the game participation has been closed due to predetermined factors, or in cases in which the gaming machine has not transmitted the bonus game participation information, the gaming machine receives the participation rejection command. Following this processing, the flow proceeds to Step S109.

Next, the management server 80 executes character information determination processing (Step S109). In this processing, the management server 80 determines the attributes of each character in the bonus game, and the order according to which each allied character plays its role in the battle game. Following this processing step, the flow proceeds to Step S110.

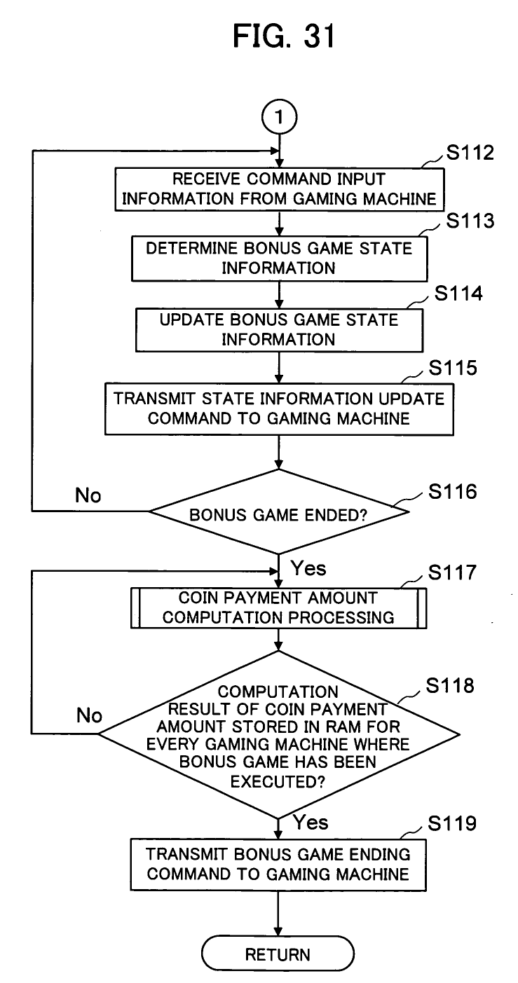

Afterwards, the management server 80 transmits a character information notification command to the gaming machines 1a through 1c (Step S110). In this case, the recipient of this command is the gaming machine 1a where the bonus game is to be executed. The character information notification command includes the information (information regarding the order according to which each allied character plays its role, etc.) determined in the processing in Step S109, and a command for instructing the gaming machines 1a through 1c to display the images shown in FIGS. 18A and 18B on the screen 6A of the second display 6 thereof. Following this processing step, the flow proceeds to Step S111. Note that, in the normal state, each allied character plays its role according to the order thus determined by the aforementioned character information determination processing (Step S110). Also, the management server may performs the character information determination processing step again, as necessary, in cases in which any one of the allied character has died, for example. In this case, the management server 80 transmits the character information notification command to the gaming machines 1 before the processing in Step S112 in FIG. 31 described later.

Next, the management server 80 transmits the bonus game start command to the gaming machines 1a through 1c (Step S111). In this case, the recipients of this command are the gaming machines 1a through 1c where the bonus game is to be executed. The bonus game start command includes a command for instructing the gaming machines 1 to display the information regarding the beginning of the bonus game and the image shown in FIG. 19 on the screen 6A of the second display 6 thereof. Following this processing, the flow proceeds to Step S112 shown in FIG. 31.

Afterwards, as shown in FIG. 31, the management server 80 receives command input information from the gaming machines 1a through 1c (Step S112). The term “command input information” as used here represents the information regarding the next action to be taken by a character in the battle game in the bonus game stage. In this processing step, the management server 80 receives the command input information transmitted in the processing in Step S204 shown in FIG. 32 executed by the gaming machines 1. Following this processing step, the flow proceeds to Step S113.

Next, the management server 80 determines the state information for the bonus game (Step S113). The term “determination of the state information for the bonus game” as used here represents determination of the information with respect to the HP of the allied characters and the enemy character, the presence or absence of a treasure box including coins, etc., based upon the command input information received in the processing in Step S112. Following this processing step, the flow proceeds to Step S114.

Afterwards, the management server 80 updates the state information for the bonus game (Step S114). In this processing step, the management server 80 stores the state information for the bonus game, determined in the processing in Step S113, in the RAM 83 (see FIG. 10) (update processing). Following this processing, the flow proceeds to Step S115.

Next, the management server 80 transmits a state information update command to the gaming machines 1a through 1c (Step S115). In this case, the recipients of this command are the gaming machines 1a through 1c where the bonus game is being executed. The term “state information update command” as used here is a command for instructing the gaming machines 1 to store the state information for the bonus game, determined in the processing in Step S113, in the RAM 123 (update processing). Following this processing step, the flow proceeds to Step S116. Note that, in cases in which the HP of any one character among the allied characters has been reduced to zero, the management server 80 transmits a notification that the battle game has ended, to the corresponding one of the gaming machines 1a through 1c, where the player is playing the corresponding character.

Afterwards, the management server 80 determines whether or not the bonus game has ended (Step S116). In this processing, the management server 80 reads out the data stored in the RAM 83, determines whether or not the HP of all the allied characters have been reduced to zero, and determines whether or not the HP of the enemy character have been reduced to zero.

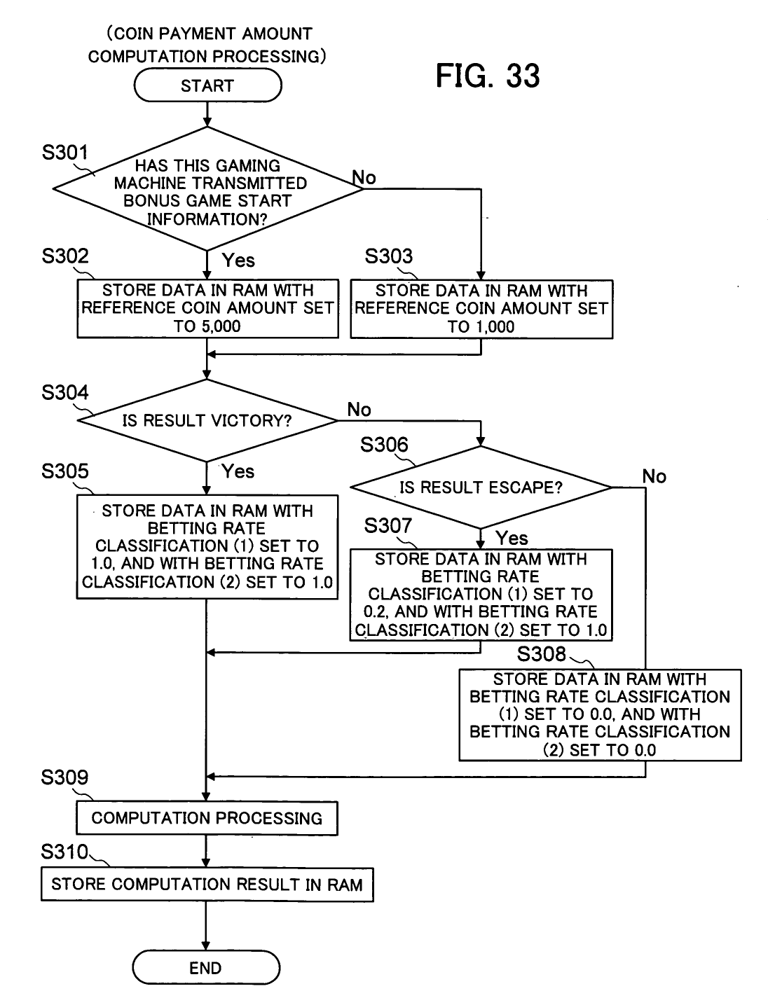

In cases in which determination has been made that the bonus game has not ended in the processing in Step S116, the flow returns to Step S112. Whereas, in cases in which determination has been made that the bonus game has ended, the management server 80 executes coin payment amount computation processing (Step S117), which will be described with reference to FIG. 33. Following this processing step, the flow proceeds to Step S118.

Next, the management server 80 determines whether or not the coin payment amount computation results have been stored in the RAM 83 for all the gaming machines 1a through 1c where the bonus game has been executed (Step S118). The term “coin payment amount computation results” as used here represents the coin payment amount computation results computation executed in Step S117.

In cases in which determination has been made that the coin payment amount computation results have not been stored in the RAM 83, in the processing in Step S118, for all the gaming machines 1a through 1c where the bonus game has been executed, the flow returns to Step S117. Whereas, in cases in which determination has been made that the coin payment amount computation results have been stored in the RAM 83 for all the gaming machines 1 where the bonus game has been executed, the management server 80 transmits a bonus game ending command to the gaming machines 1a through 1c (Step S119). The term “bonus game ending command” as used here represents the information including coin payment amount computation results and a notification that the bonus game has ended. Following this processing step, the flow returns to Step S101 shown in FIG. 30.

Afterwards, description will be made regarding gaming machine side bonus game control processing with reference to FIG. 32. This processing is executed in Step S19 shown in FIG. 29.

First, as shown in FIG. 32, the CPU 121 receives the character information notification command (Step S201). In this processing step, the CPU 121 receives the character information notification command transmitted in the processing in Step S110 in FIG. 30 executed by the management server 80. Furthermore, the CPU 121 transmits a signal to the sub-control circuit 171 (see FIG. 8) for instructing the gaming machines 1a through 1c to display the images as shown in FIGS. 18A and 18B on the screen 6A of the second display 6 thereof. Following this processing step, the flow proceeds to Step S202.

Next, the CPU 121 executes bonus game start processing according to instructions from the management server 80 (Step S202). In this processing step, the CPU 121 receives the bonus game start command, which has been transmitted from the management server 80 in Step S111 shown in FIG. 30. Following this processing step, the flow proceeds to Step S203.

Next, the CPU 121 executes the bonus game start processing (Step S203). In this processing step, the CPU 121 transmits a signal to the sub-control circuit 171 to instruct the gaming machines 1a through 1c to display the image as shown in FIG. 19 on the screen 6A of the second display 6 thereof. Following this processing step, the flow proceeds to Step S204.

Next, the CPU 121 transmits the command input information to the management server 80 (Step S204). Following this processing step, the flow proceeds to Step S205. Note that, in cases in which the order of the actions of the allied characters in the battle game changes due to the death of any one of the allied characters, the CPU 121 receives the character information notification command from the management server 80 after the processing in Step S208.

Afterwards, the CPU 121 receives the state information update command from the management server 80 (Step S205). In this processing step, the CPU 121 receives the state information update command which has been transmitted in the processing in Step S115 shown in FIG. 30 executed by the management server 80. Following this processing step, the flow proceeds to Step S206.

Next, the CPU 121 executes the state information update processing (Step S206). In this processing step, the CPU 121 stores the information included in the state information update command received in the processing in Step S205 (update processing). Following this processing step, the flow proceeds to Step S207.

Afterwards, the CPU 121 executes bonus game midstream processing (Step S207). In this processing step, the CPU 121 transmits a signal to the sub-control circuit 171 to instruct the gaming machines 1 to display the image as shown in FIG. 21 on the screen 6A of the second display 6 thereof. Following this processing step, the flow proceeds to Step S208.

Next, the CPU 121 determines whether or not the gaming machine has received the bonus game ending command from the management server 80 (Step S208). In this processing step, the CPU 121 determines whether or not the gaming machine has received the bonus game ending command transmitted in the processing in Step S119 shown in FIG. 31 executed by the management server 80. In cases in which any one of the options of “victory”, “escape”, or “defeat” is decided in the battle game stage, the management server 80 transmits the bonus game ending command to all the gaming machines 1a through 1c (except for the gaming machines 1d through 1h in which the battle game is not being executed). Also, in cases in which the HP of any one of the allied characters has been reduced to zero in the battle game stage, the management server 80 transmits the bonus game ending command to the gaming machine 1 where the player is playing this allied character.

In cases in which determination has been made that the gaming machine has not received the bonus game ending command from the management server 80 in the processing in Step S208, the flow returns to Step S204. Whereas, in cases in which determination has been made that the gaming machine has received the bonus game ending command from the management server 80, the CPU 121 receives the bonus game ending command from the management server 80 (Step S209). Following this processing step, the flow proceeds to Step S210.

Afterwards, the CPU 121 executes the coin payment processing (Step S210). Following this processing step, the flow proceeds to Step S211.

Next, the CPU 121 executes bonus game ending processing (Step S211). In this processing step, the CPU 121 transmits a signal to the sub-control circuit 171 to instruct the gaming machines 1 to display the images as shown in FIG. 23 through FIG. 27 on the screen 6A of the second display 6 thereof. Following this processing step, the flow returns to Step 1 shown in FIG. 28.

Afterwards, description will be made regarding the coin payment amount computation processing with reference to FIG. 33. This processing is executed in Step S117 shown in FIG. 31.

First, as shown in FIG. 33, the management server 80 determines whether or not the gaming machine 1, which has requested coin payment amount computation results according to the flowchart shown in FIG. 33, matches the gaming machine 1a (where the player has initiated a bonus game) which has transmitted the bonus game start information to the management server 80 (Step S11 in FIG. 29). This determination step allows the management server 80 to obtain the information regarding whether the player at the gaming machine 1, which has requested coin payment amount computation results according to the flowchart shown in FIG. 33, is playing a role of the “leader” or of the “partner”.

In cases in which determination has been made in Step S301 that the gaming machine 1, which has requested coin payment amount computation results according to the flowchart shown in FIG. 33, matches the gaming machine 1a (where the player has initiated a bonus game) which has transmitted the bonus game start information to the management server 80 (Step S11 in FIG. 29), the management server 80 stores data in the RAM 83 with the standard coin payment amount set to 5,000 (Step S302). Following this processing step, the flow proceeds to Step S304.

However, in cases in which determination has been made in Step S301 that the gaming machine 1, which has requested coin payment amount computation results according to the flowchart shown in FIG. 33, does not match the gaming machine 1a (where the player has initiated a bonus game) which has transmitted the bonus game start information to the management server 80 (Step S11 in FIG. 29), the management server 80 stores data in the RAM 83 with the standard coin payment amount set to 1,000 (Step S302).

Next, the management server 80 determines whether or not the result of the bonus game is “victory” (Step S304). In this processing step, the management server 80 reads out the data stored in the RAM 83, and determines whether or not the HP of the enemy character have been reduced to zero.

In cases in which determination has been made that the result of the bonus game is “victory” in the processing in Step S304, the management server 80 stores data in the RAM 83 with the betting rate classification (1) set to 1.0, and with the betting rate classification (2) set to 1.0 (Step S305). Following this processing step, the flow proceeds to Step S309.

However, in cases in which determination has been made that the result of the bonus game is not “victory” in the processing in Step S304, the management server 80 determines whether or not result of the bonus game is “escape” (Step S306). In this processing step, the management server 80 determines whether or not the management server 80 has received a signal as a result of the player pressing the decision switch 25 after selecting the option “escape” from the command menu displayed in the image as shown in FIG. 20.

In cases in which determination has been made that the result of the bonus game is “escape” in the processing in Step S306, the management server 80 stores data in the RAM 83 with the betting rate classification (1) set to 0.2, and with the betting rate classification (2) set to 1.0 (Step S307). Following this processing step, the flow proceeds to Step S309.

Whereas, in cases in which determination has been made that the result of the bonus game is not “escape” in the processing in Step S306, the management server 80 stores data in the RAM 83 with the betting rate classification (1) set to 0.0, and with the betting rate classification (2) set to 0.0 (Step S308). Following this processing step, the flow proceeds to Step S309. Note that, in cases in which the HP of any one of the allied characters have been reduced to zero, the processing in Step S308 is executed.

Afterwards, the management server 80 executes computation processing (Step S309). In this processing step, the management server 80 executes computation processing for computing the coin payment amount using the computation expression for calculating the coin payment amount shown in FIG. 11. In this computation processing, the computation processing for computing the coin payment amount is executed based upon the coefficients and parameters stored in the RAM 83 in Step S302, Step S303, Step S305, Step S307, and Step S308, the number of coins included in the treasure box acquired in the bonus game, and the number of the gaming machines where the bonus game is being executed.

Next, the management server 80 store the computation results in the RAM 83 (Step S310). In this processing step, the management server 80 stores the computation results of the computation processing executed in Step S309. Following this processing step, the flow proceeds to Step S118 shown in FIG. 31.

While a description has been made regarding the first embodiment, the present invention is not restricted to such an arrangement.

While description has been made in the present embodiment regarding an arrangement in which the enemy character comprises a single dragon, the present invention is not restricted to such an arrangement. Also, an arrangement may be made in which there are multiple enemy characters. For example, an arrangement may be made in which the multiple enemy characters comprises a single main character and one or more sub-characters.

A description has been made in the present embodiment regarding an arrangement in which, if the result of the bonus game is “victory” or “escape”, the coin payment amount is not reduced to zero for the gaming machine where the character played by a player has died as a result of the character's HP being reduced to zero. The present invention is not restricted to such an arrangement. Also, an arrangement may be made in which such a case leads to the coin payment amount being reduced to zero. In other words, an arrangement may be made in which the result of the bonus game “victory” is further classified into two types, i.e., “victory (with HP other than zero)” and “victory (with HP of zero)”. Furthermore, in a case of the “victory (with HP of zero)”, the betting rate classification (1) and the betting rate classification (2) are set to 0.0. Also, an arrangement may be made in which the result of the bonus game “escape” is further classified into two types, i.e., “escape (with HP other than zero)” and “escape (with HP of zero)”. Furthermore, in a case of the “escape (with HP of zero)”, the betting rate classification (1) and the betting rate classification (2) are set to 0.0. In such an arrangement, in cases in which a character has died as a result of the character's HP being reduced to zero, the coin payment amount is set to zero even in a case of the result of the bonus game of “victory” or “escape”.

A description has been made in the present embodiment regarding an arrangement in which the coins included in the treasure box acquired from the enemy character are evenly divided among the allied characters, and the coins thus divided are paid out to the gaming machines where the players are playing the corresponding characters, as shown in FIG. 11. The present invention is not restricted to such an arrangement. Also, an arrangement may be made in which all the coins included in the treasure box are won by the player who is playing the role of a particular allied character, e.g., the leader in the battle game.

A description has been made in the present embodiment regarding an arrangement in which, in cases in which the dragons are displayed along the payline 8 after the rotation of all the reels 3L, 3C, and 3R stops in the slot game stage of at least one of the multiple gaming machines 1, the bonus game is executed. However, the present invention is not restricted to such an arrangement. Also, an arrangement may be made in which, in cases in which a player has won in a lottery conducted using random number sampling, the bonus game is executed (with such an arrangement, either the management server 80 or each gaming machine 1 may have a function of random number sampling). Also, an arrangement may be made in which, when the number of rounds of the game (slot game) has exceeded a predetermined number, the bonus game is executed. Also, an arrangement may be made in which, when a predetermined period of time has elapsed after the previous bonus game, the bonus game is executed. Also, an arrangement may be made in which, when the number of coins inserted in the slot game stage has exceeded a predetermined number, the bonus game is executed. Also, an arrangement may be made in which, when the number of coins paid out has exceeded a predetermined number, the bonus game is executed. Also, an arrangement may be made in which, in cases in which one or more particular symbols are displayed in a portion of the display region other than the region along the valid line, the bonus game is executed.

A description has been made regarding the gaming system using a so-called client/server network with the management server 80 as a server, and with each gaming machine as a client. However, the present invention is not restricted to such an arrangement. Also, the gaming system according to the present embodiment may be implemented using a network, which does not employ the aforementioned management server, such as a peer-to-peer network.

### Second Embodiment

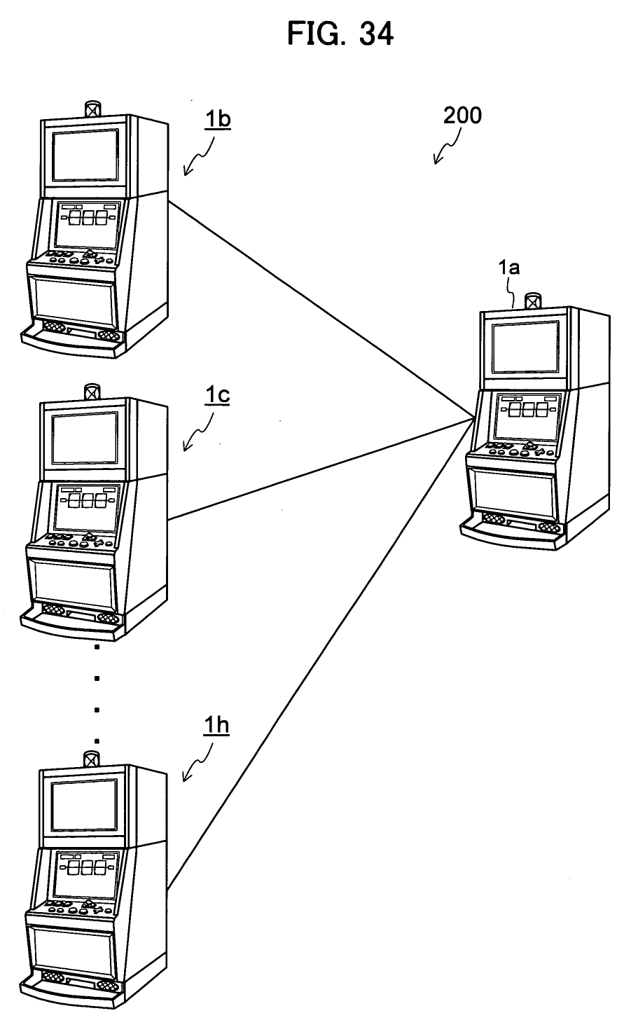

Next, a description will be made regarding a second embodiment with reference to FIG. 34. Note that description will be made regarding only the components which differ from those in the first embodiment. In general, the same components as those in the first embodiment will be omitted.

As shown in FIG. 7, the gaming system 100 according to the first embodiment is a gaming system formed using a so-called client/server network in which the multiple gaming machines 1a through 1h and the management server 80 are connected so as to allow communication of predetermined information to be made therebetween.

Furthermore, as shown in FIG. 34, a gaming system 200 according to the second embodiment is formed using a client/server network in the same way as the gaming system 100 according to the first embodiment. The difference is that the second embodiment includes no separate management server 80 in addition to the gaming machines 1a through 1h. A description will be made in the second embodiment regarding an arrangement in which any one of the gaming machines 1a through 1h has the same functions as those of the management server 80 in the first embodiment. Note that, in the description in the present embodiment, the peripheral devices etc. which form the gaming machine 1a are denoted by reference numerals with the suffix “a”. In the same way, the peripheral devices etc. which form the gaming machines 1b through 1h are denoted by reference numerals with a corresponding suffix “b” through “h”. For example, the ROM 122 which is a component of the gaming machine 1a will be denoted by “ROM 122a”.

FIG. 34 is an explanatory diagram which shows an overall schematic configuration of the gaming system 200 according to the second embodiment. The gaming system is formed of multiple gaming machines 1. The gaming machine 1a is connected with each of the gaming machines 1b through 1h via communication device such as LAN cables or the like, which allow the gaming machines to transmit and receive predetermined information. In such an arrangement, of these gaming machines 1a through 1h, the gaming machine 1a includes communication control device having the same functions as those of the server described above. Note that the gaming machines 1b through 1h other than the gaming machine 1a include no communication control device, unlike the gaming machine 1a. A description will be made later regarding the communication control device of the gaming machine 1a.

Note that each of the gaming machines 1a through 1h forming the gaming system according to the present embodiment may include master/slave determining device which allows each gaming machine to be switched between a master machine which operates as a server in the present gaming system and a slave machine which operates as a client. In such an arrangement, each gaming machine 1 includes the communication control device having the same functions as those of the management server 80. A particular gaming machine among the gaming machines 1, which has been set to be a master machine by the master/slave determining device, controls communication processing of the present gaming system by actions of the communication control device thereof in the same way as with the management server 80.

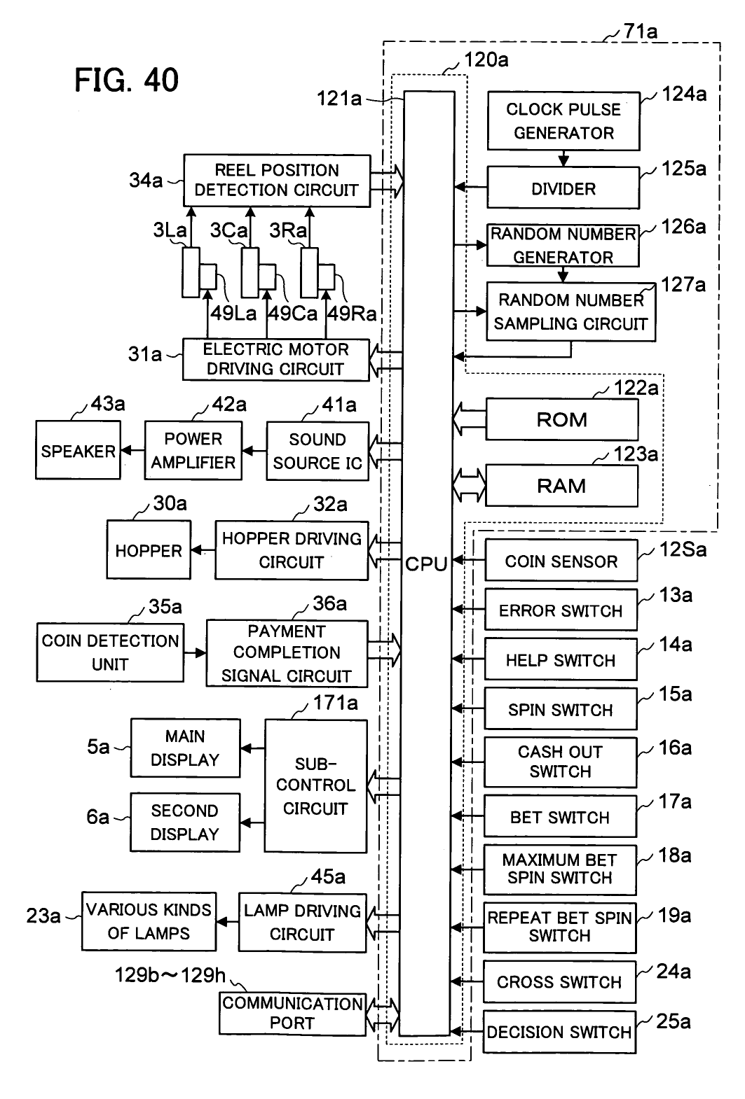

Next, a description will be made regarding the aforementioned communication control device of the gaming machine 1a with reference to FIG. 40. FIG. 40 shows a circuit configuration including: a main control circuit 71a for controlling the game processing operation of the gaming machine 1a; peripheral devices (actuators) electrically connected to the main control circuit 71a; and a sub-control circuit 171a for controlling a main display 5a and a second display 6a according to control instructions transmitted from the main control circuit 71. Note that CPU 121a of the main control circuit 71a is connected to the actuators through an input port and an output port, which are not shown in the drawing in the same way as in the first embodiment. Whereas, the main control circuit 71a etc. for controlling the game processing operation of the gaming machine 1a have the same functions as those of the main control circuit 71 etc. according to the first embodiment shown in FIG. 8. Accordingly, description will be omitted regarding the main control circuit 71 etc.

As shown in FIG. 40, ROM 122a included in the gaming machine 1 also stores the communication control program etc., which is transmitted to the CPU 121a. The ROM 122a also stores the coin acquisition computation expression, a standard coin payment table, a betting classification table, and a treasure-box coin amount table as described in the first embodiment (see FIG. 11(a) through FIG. 11(c)). With such an arrangement, the CPU 121a is connected to communication ports 129b through 129h. Furthermore, the communication ports 129b through 129h are connected to the gaming machines 1b, 1c, . . . , 1h, respectively. This allows the CPU 121a to identify each of the gaming machines 1 using the identification numbers of the communication ports. Whereas, the RAM 123a temporarily stores information or the like transmitted via the communication ports 129b through 129h, and is used as a work memory area for computation processing executed by the CPU 121a.

The gaming system 200 according to the second embodiment provides the same bonus game as with the first embodiment described above (see FIG. 13 through FIG. 27). Note that the gaming machine 1a has the same server function as that of the management server 80 according to the first embodiment.

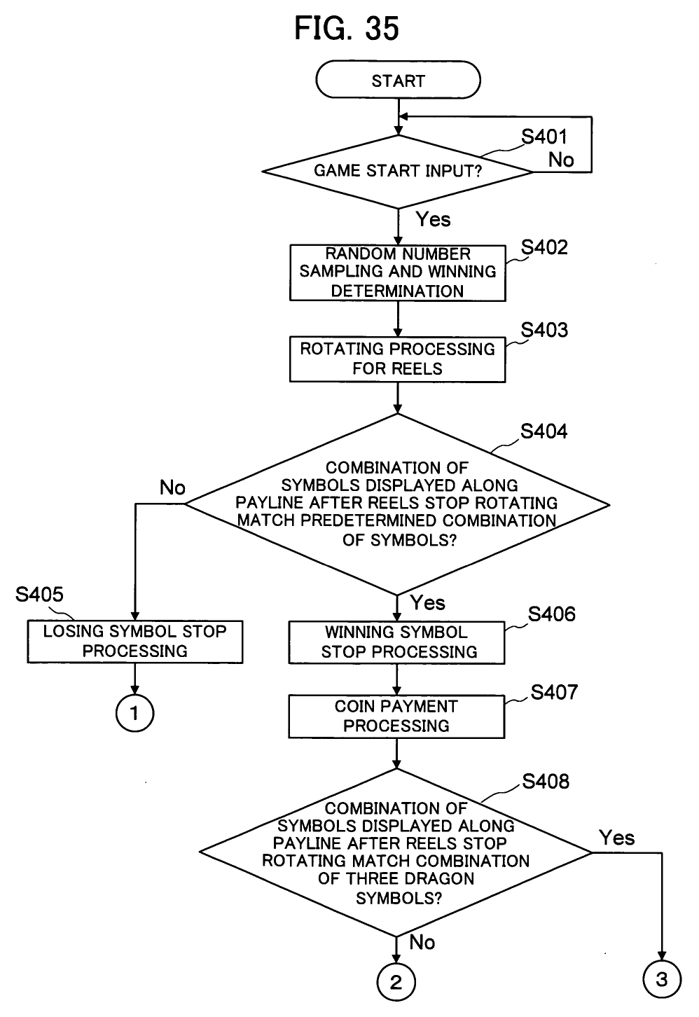

Afterwards, a description will be made regarding the outline of the control operation of the CPU 121a included in the main control circuit 71a of the gaming machine 1a according to the second embodiment with reference to the flowchart shown in FIG. 35. Note that the Steps S401 through S404 shown in FIG. 35 are the same as the Steps S1 through S4 according to the first embodiment shown in FIG. 28, and accordingly, a description thereof will be omitted.

Also, the control operations of the CPUs 121b through 121h of the main control circuits 71a through 71h included in the gaming machines 1b through 1h, each of which is connected to the gaming machine 1a through a LAN cable, are the same as the control operation of the CPU 121 of the main control circuit 71 included in each gaming machine 1 according to the first embodiment. Accordingly, in the present embodiment, description will be omitted regarding the control operations of the CPUs 121b through 121h. Also, the management server side bonus control processing according to the present embodiment is the same as the management server side bonus control processing according to the first embodiment, and accordingly, a description thereof will be omitted.

First, let us say that the determination has been made that the combination of the symbols to be displayed along the payline 8a after the rotation of all the reels 3La, 3Ca, and 3Ra stops does not match any one of the predetermined combinations of symbols (e.g., a symbol combination such as “WILD—red 7—1BAR”) in Step S404 as shown in FIG. 5. In this case, the CPU 121a executes losing symbol stop processing (Step S405). In this processing step, the CPU 121a transmits a signal to an electric motor driving circuit 31a for controlling so as to stop the rotation of the reels 3La, 3Ca, and 3Ra corresponding to the symbols to be displayed after the rotation of the reels stops, which has been determined in the processing in Step S403. In this processing step, the reels are controlled such that the combination of the symbols displayed along the payline 8 after the rotation of the reels 3La, 3Ca, and 3Ra stops does not match any one of the predetermined symbol combinations as shown in FIG. 5. After this processing step, the flow returns to Step S401.

Whereas, let us say that determination has been made that the combination of the symbols to be displayed along the payline 8a after the rotation of all the reels 3La, 3Ca, and 3Ra stops matches any one of the predetermined combinations of symbols in Step S404 as shown in FIG. 5. In this case, the CPU 121a executes winning symbol stop processing (Step S406). In this processing step, the CPU 121a transmits a signal to the electric motor driving circuit 31a for stopping rotation of the reels 3La, 3Ca, and 3Ra corresponding to the winning symbols determined in the processing in Step S403. Furthermore, the reels are controlled such that the combination of the symbols displayed along the payline 8 after the rotation of the reels 3La, 3Ca, and 3Ra stops matches any one of the predetermined symbol combinations as shown in FIG. 5. After this processing step, the flow returns to Step S407.

Afterwards, the CPU 121a executes a coin payment processing (Step S407). Following this processing step, the flow proceeds to Step S408.

Next, the CPU 121a determines whether or not the combination of the symbols displayed along the payline 8a after all the reels 3La, 3Ca, and 3Ra stop rotating matches the combination of the symbols of the three dragons (Step S408).

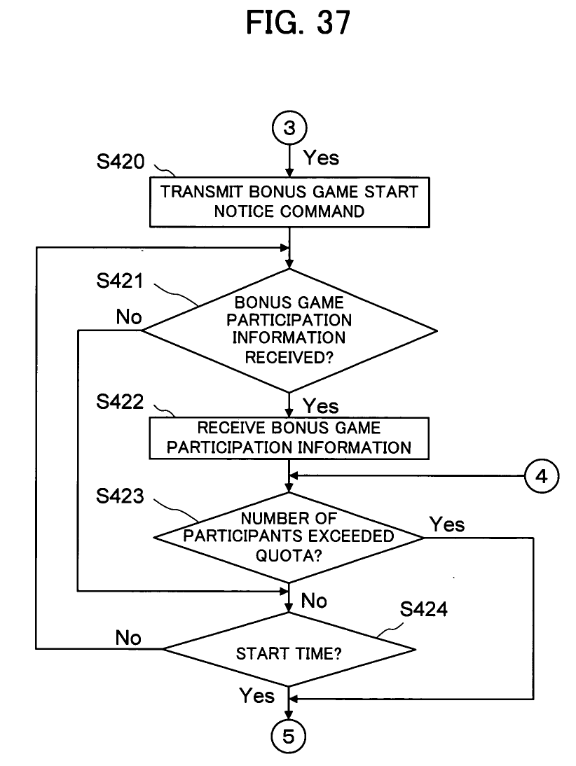

In cases in which determination has been made that the combination of the symbols displayed along the payline 8a after all the reels 3La, 3Ca, and 3Ra stop rotating matches the combination of the symbols of the three dragons in the processing in Step S408, the flow proceeds to Step S420 shown in FIG. 37.

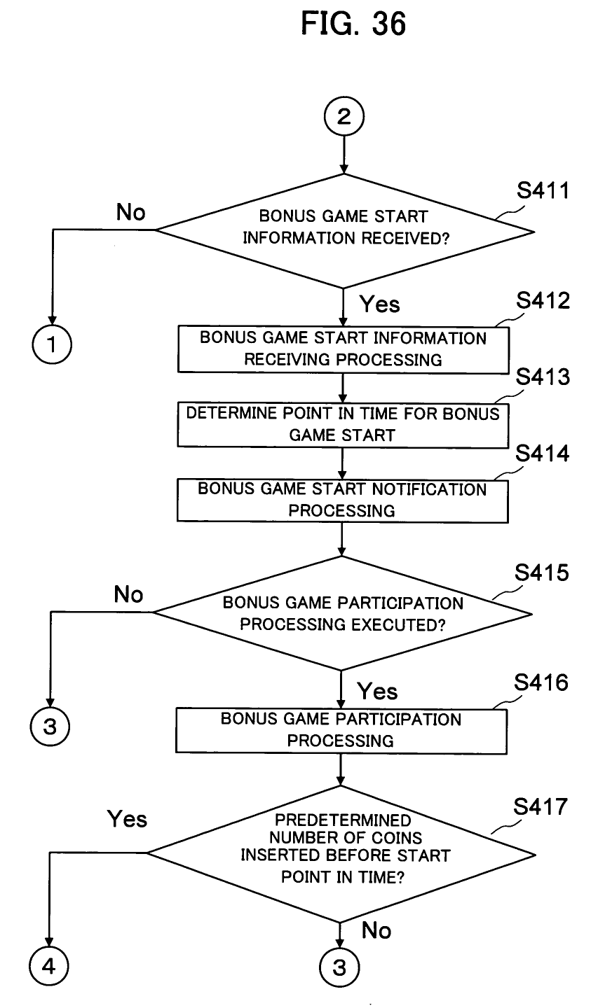

In cases in which determination has been made that the combination of the symbols displayed along the payline 8a after all the reels 3La, 3Ca, and 3Ra stop rotating does not match the combination of the symbols of the three dragons in the processing in Step S408 as shown in FIG. 36, the CPU 121a determines whether or not the gaming machine 1a has received the bonus game start information from the other gaming machines 1b through 1h (Step S411). In this processing step, the CPU 121a determines whether or not the gaming machine 1a has received the bonus game start information transmitted in the processing step (Step S11 shown in FIG. 29 described later) executed by the other gaming machines 1b through 1h.

In cases in which determination has been made that the gaming machine 1a has not received a bonus game start information from the other gaming machines 1b through 1h in Step S411, the flow returns to Step S401 shown in FIG. 35. Whereas, in cases in which the gaming machine 1a has received a bonus game start information from the other gaming machines 1b through 1h, the CPU 121a executes bonus game start information reception processing (Step S412). Following this processing step, the flow proceeds to Step S403.

Afterwards, the CPU 121a determines the point in time at which the bonus game is to be started (Step S413). Following this processing step, the flow proceeds to Step S414.

Next, the CPU 121a executes the bonus game start notice transmission processing (Step S414). In this processing step, the CPU 121a transmits a bonus game start notice command to each of other gaming machines 1b through 1h. Whereas, in a case of “No” in Step S408 in FIG. 35, the CPU 121a transmits a signal to the sub-control circuit 171a so as to instruct this circuit to display the image shown in FIG. 14 on the screen 6Aa of the second display 6a. Following this processing step, the flow proceeds to Step S415.

Afterwards, the CPU 121a determines whether or not the bonus game participation processing has been executed (Step S415). In this processing step, the CPU 121a determines whether or not the CPU 121 has received a signal generated as a result of the player operating a decision switch 25a in a period of time in which the image shown in FIG. 14 is displayed.

In cases in which determination has been made that the bonus game participation processing has not been executed in Step S415, the flow proceeds to Step S420 shown in FIG. 37. Whereas, in cases in which determination has been made that the bonus game participation processing has been executed, the CPU 121a executes the bonus game participation processing (Step S416). Following this processing step, the flow proceeds to Step S417.

Next, the CPU 121a determines whether or not the predetermined number of coins required for participation in the bonus game have been inserted before the point in time which has been determined in Step S414 as the point in time at which the bonus game is to be started (Step S417).

In cases in which determination has been made in Step S417 that the predetermined number of coins required for participation in the bonus game have been inserted before the point in time which has been determined in Step S414 as the point in time at which the bonus game is to be started, the flow proceeds to Step S423. Whereas, in cases in which determination has been made that the predetermined number of coins required for participation in the bonus game have not been inserted before the point in time which has been determined in Step S414 as the point in time at which the bonus game is to be started, the CPU 121a transmits a bonus game notification command to each of the gaming machines 1b through 1h,(Step S420). Following this processing step, the flow proceeds to Step S421.

Afterwards, the CPU 121a determines whether or not the gaming machine 1a has received bonus game participation information from any one of the other gaming machines 1b through 1h,(Step S421).

In cases in which determination has been made in Step S421 that the gaming machine 1a has not received the bonus game participation information from any one of the other gaming machines 1b through 1h, the flow proceeds to Step S424. Whereas, in cases in which determination has been made that the gaming machine 1a has received bonus game participation information from any one of the other gaming machines 1b through 1h, the CPU 121a executes the bonus game participation information reception processing (Step S422). Following this processing step, the flow proceeds to Step S423.

Next, the CPU 121a determines whether or not the number of the gaming machines which are to participate in the bonus game has exceeded a predetermined quota (Step S423).

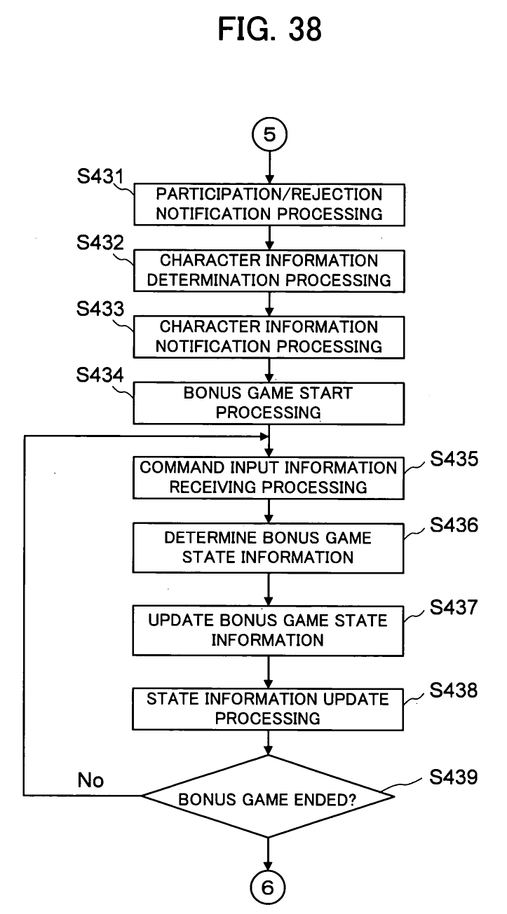

In cases in which determination has been made in Step S423 that the number of the gaming machines which are to participate in the bonus game has exceeded the predetermined quota, the flow proceeds to Step S431 shown in FIG. 38. Whereas, in cases in which determination has been made that the number of the gaming machines which are to participate in the bonus game has not exceeded the predetermined quota, the CPU 121a determines whether or not the point in time at which the bonus game is to be started has been reached (Step S424).

In cases in which determination has been made in Step S424 that the point in time at which the bonus game is to be started has not yet been reached, the flow returns to Step S421. Whereas, in cases in which determination has been made that the point in time at which the bonus game is to be started has been reached, the CPU 121a transmits a participation rejection command to each of the other gaming machines 1b through 1h, as shown in FIG. 37. Furthermore, the CPU 121a transmits a signal to the sub-control circuit 171a so as to instruct to this circuit to display the image shown in FIG. 15 on the screen 6A of the second display 6a. Following this processing step, the flow proceeds to Step S432.

Afterwards, the CPU 121a executes the character information determination processing (Step S432). In this processing step, the CPU 121a determines the attributes of the characters in the bonus game, the order of the actions of the characters, etc. Following this processing step, the flow proceeds to Step S433.

Next, the CPU 121a executes character information notification processing (Step S433). In this processing step, the CPU 121a transmits the character information notification command to each of the other gaming machines 1b through 1h where the bonus game is being executed. The character information notification command includes the information determined in the processing in Step s433, a command for instructing the other gaming machines 1b through 1h,to display the image shown in FIG. 18 on the screen 6A of the second display 6 thereof, etc. Also, in cases in which the bonus game is being executed at the gaming machine 1a, the CPU 121a transmits a signal to the sub-control circuit 171a (see FIG. 40) so as to instruct this circuit to display the image as shown in FIG. 18 on the screen 6Aa of the second display 6a. Following this processing step, the flow proceeds to Step S434.

Afterwards, the CPU 121a executes the bonus the game start processing (Step S434). In this processing step, the CPU 121a transmits the bonus game start command to each of the other gaming machines 1b through 1h. The bonus game start command includes the information used in the initiation of a bonus game, a command for instructing the other gaming machines 1b through 1h,to display the image shown in FIG. 19 on the screen 6A of the second display 6 thereof, etc. Also, in cases in which the bonus game is being executed at the gaming machine 1a, the CPU 121a transmits a signal to the sub-control circuit 171a so as to instruct this circuit to display the image as shown in FIG. 19 on the screen 6Aa of the second display 6a. Following this processing step, the flow proceeds to Step S435.

Next, the CPU 121a executes command input information reception processing (Step S435). In this processing step, the CPU 121a receives command input information from the other gaming machines 1b through 1h. The term “command input information” as used here represents the information that indicates the next actions of a character in a battle game. Also, in cases in which the bonus game is being executed at the gaming machine 1a, the image shown in FIG. 20 is displayed. In this stage, the player operates the decision switch 25a, whereupon a generated signal is received. Following this processing step, the flow proceeds to Step S436.

Afterwards, the CPU 121a determines the state information for the bonus game (Step S436). The term “determination of the state information for a bonus game” represents a determination, which corresponds to the command input information input in Step S435, of the HP of the friend and enemy characters, the appearance of a treasure box including coins, etc. Following this processing step, the flow proceeds to Step S437.

Next, the CPU 121a updates the state information for the bonus game (Step S437). In this processing step, the CPU 121a stores the state information for the bonus game, which has been determined in Step S436, in the RAM 123a (see FIG. 40) (update processing). Following this processing step, the flow proceeds to Step S438.

Next, the CPU 121a executes the state information update processing (Step S438). In this processing step, the CPU 121a transmits a state information update command to each of the gaming machines 1b through 1h. The term “state information update command” as used here represents a command for instructing the other gaming machines 1b through 1h, to store the state information for the bonus game, which has been determined in Step S436, in the RAM 123 (i.e., to update the state information). Also, in cases in which the bonus game is being executed at the gaming machine 1a, the CPU 121a executes bonus game midstream processing. In this processing step, the CPU 121 transmits a signal to the sub-control circuit 171 so as to instruct this circuit to display the images as shown in FIG. 21 on the screen 6A of the second display 6 of the gaming machine 1. Following this processing step, the flow proceeds to Step S439.

Afterwards, the CPU 121a determines whether or not the bonus game is to end (Step S439). In this processing step, the CPU 121a reads out the data stored in the RAM 83a. Subsequently, the CPU 121a determines whether or not the HP of all the allied characters have been reduced to zero, whether or not the HP of the enemy character have been reduced to zero, etc.

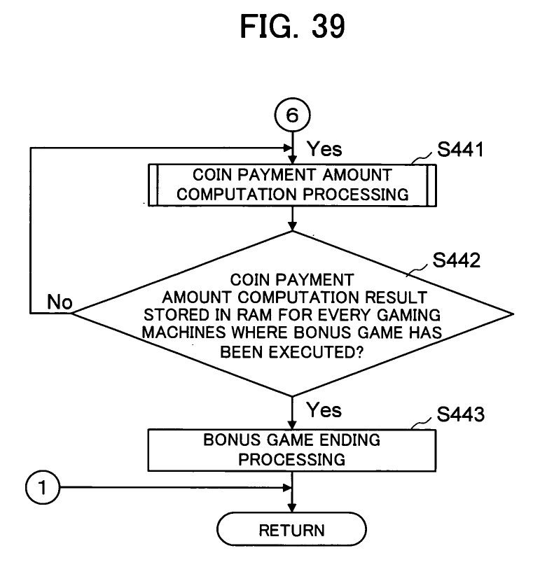

In cases in which determination has been made that the bonus game is not to end in Step S439, the flow returns to Step S435. Whereas, in cases in which determination has been made that the bonus game is to end, the CPU 121a executes the coin payment amount computation processing, described with reference to FIG. 33, as shown in FIG. 39 (Step S441). Following this processing step, the flow proceeds to Step S442.

Then, the CPU 121a determines whether or not coin payment amount computation results have been stored in the RAM 123a for all the gaming machines 1 where the bonus game has been executed (Step S442). The term “coin payment amount computation results” as used here represents computation results obtained in the coin payment amount computation processing executed in Step S441.

In cases in which determination has been made in Step S442 that the coin payment amount computation results have not been stored in the RAM 123a for all the gaming machines 1 where the bonus game has been executed, the flow proceeds to Step S443. Whereas, in cases in which determination has been made that the coin payment amount computation results have been stored in the RAM 123a for all the gaming machines 1 where the bonus game has been executed, the CPU 121a executes bonus game ending processing (Step S443). In this processing step, the CPU 121a transmits a bonus game ending command to each of the gaming machines 1b through 1h. Also, in cases in which the bonus game is being executed at the gaming machine 1a, the CPU 121a transmits a signal to the sub-control circuit 171a so as to instruct this circuit to display the images as shown in FIGS. 23 through 27 on the screen 6Aa of the second display 6a. Furthermore, in cases in which coins are to be paid out, the CPU 121a executes coin payment processing. Following this processing step, the flow returns to Step S401.

### Third Embodiment

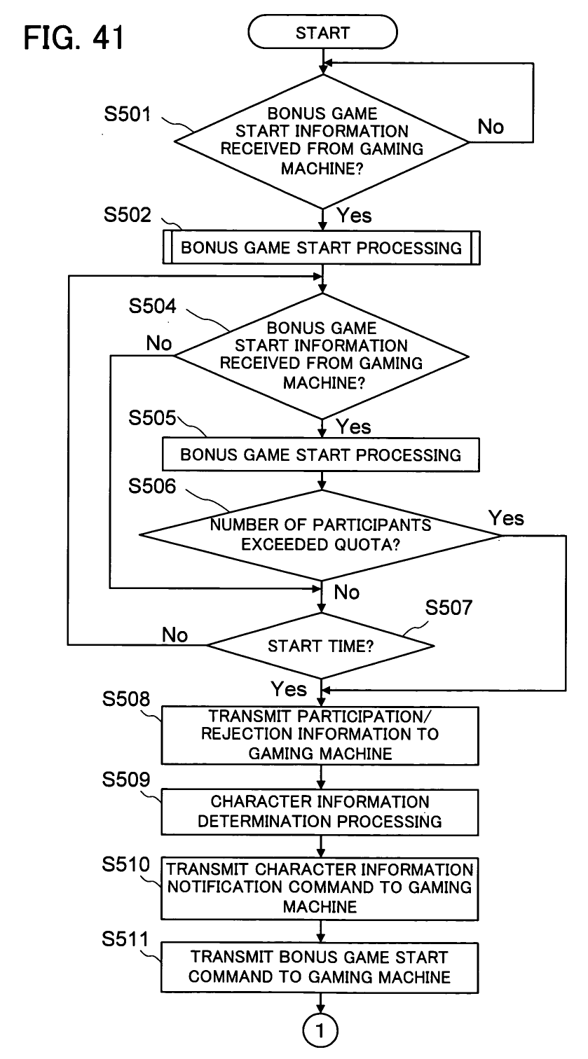

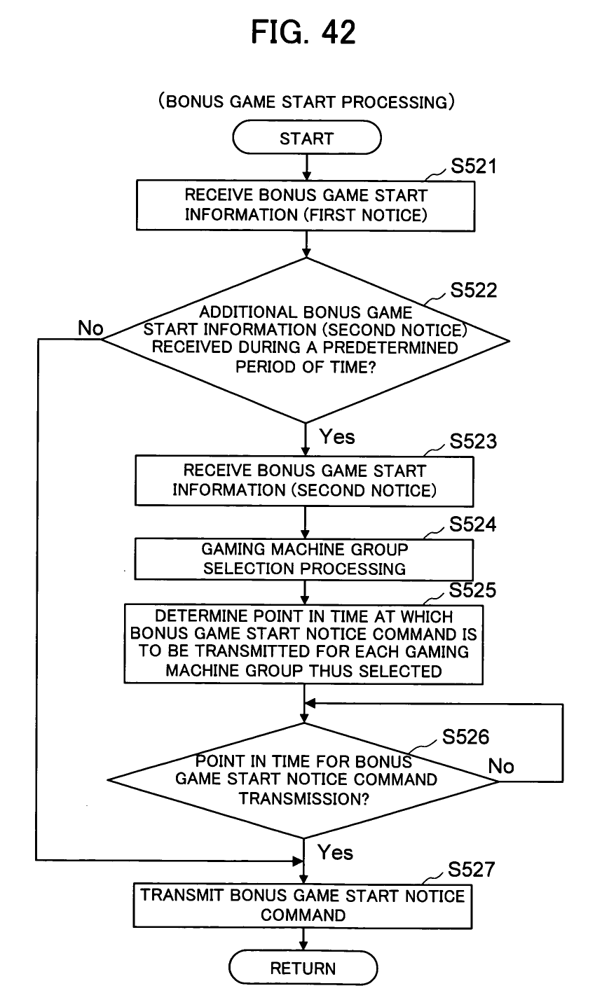

Next, description will be made regarding a third embodiment with reference to FIG. 41 and FIG. 42. Note that a description will be made regarding only components which differ from those in the first embodiment. In general, description will be omitted regarding the same components as those in the first embodiment.

A description has been made in the first embodiment regarding the management server side bonus game control processing with reference to FIG. 30, which is executed by the management server 80 in cases in which a single bonus game has been triggered. Now, a description has been made in the present embodiment regarding control processing executed by the management server 80 in cases in which two bonus games have been triggered.

Note that the bonus game according to the third embodiment performed by the gaming system 200 is the same as that described in the first embodiment (see FIG. 13 through FIG. 27).

Next, a description will be made regarding management server side bonus game control processing according to the third embodiment with reference to the flowcharts shown in FIG. 41 and FIG. 42. As described above, the term “management server side bonus game control processing” as used here represents the processing executed by the management server 80 in a bonus game stage. In particular, a description will be made in the present embodiment regarding the management server side bonus game control processing executed by the management server 80 in cases in which two bonus games have been triggered in a predetermined period of time. Note that Step S503 through Step S511 shown in FIG. 41 are the same as Step S103 through Step S111 shown in FIG. 30 described in the first embodiment, and accordingly, a description thereof will be omitted. Also, the control operation of the CPU 121 of the main control circuit 71 included in the gaming machine 1 according to the present embodiment is the same as that shown in the flowchart in FIG. 28, FIG. 29, and FIG. 32 described in the first embodiment, and accordingly, a description thereof will be omitted.

First, as shown in FIG. 41, the management server 80 determines in Step S501 whether or not the management server 80 has received bonus game start information from the gaming machines 1. In this processing step, the management server 80 determines whether or not the management server 80 has received bonus game start information transmitted in the processing (Step S11 in FIG. 29) executed by the gaming machines 1.

In cases in which determination has been made in Step S501 that the management server 80 has not received bonus game start information (first notice) from any one of the gaming machines 1, the processing in Step S501 is repeated. Whereas, in cases in which determination has been made that the management server 80 has received the bonus game start information (first notice) from any one of the gaming machines 1, the management server 80 determines the point in time at which the bonus game is to be started (Step S502). A detailed description will be made later with reference to FIG. 42. Following this processing step, the flow proceeds to Step S503.

Next, a description will be made with reference to FIG. 42 regarding bonus game start processing executed in Step S502 shown in FIG. 41.

Afterwards, as shown in FIG. 42, the management server 80 receives the bonus game start information (first notice) from the gaming machine 1a in Step S521. Following this processing step, the flow proceeds to Step S522.

Next, the management server 80 determines whether or not the management server 80 has received additional bonus game start information (second notice) in a predetermined period of time (Step S522). In this processing step, in cases in which determination has been made that the management server 80 has received additional bonus game start information (second notice) in the predetermined period of time, the flow proceeds to Step S527. Whereas, in cases in which determination has been made that the management server 80 has not received any additional bonus game start information (second notice) in the predetermined period of time, the flow proceeds to Step S523.

Afterwards, the management server 80 executes gaming machine group selection processing. In this processing step, the management server 80 selects a gaming machine group where the players can participate in a bonus game executed according to the bonus game start information (first notice) and another gaming machine group where the players can participate in a bonus game executed according to the bonus game start information (second notice) from among all the gaming machines 1a through 1h. Following this processing step, the flow proceeds to Step S525.

Next, the management server 80 determines the point in time at which a bonus game start notice command is to be transmitted to the gaming machines for each gaming machine group thus selected. Following this processing step, the flow proceeds to Step S526.

Afterwards, the management server 80 determines whether or not the point in time at which the bonus game start notice command is to be transmitted has been reached (Step S526). In cases in which determination has been made that the point in time at which the bonus game start notice command is to be transmitted has not reached, the processing in Step S526 is repeated. Whereas, in cases in which determination has been made that the point in time at which the bonus game start notice command is to be transmitted has reached, the flow proceeds to Step S527.

Afterwards, the management server 80 transmits a bonus game start notice command to each of the gaming machines (Step S103). In this case, the recipients of this command are all the gaming machines 1a through 1h. Following this processing step, the present subroutine ends.

As described above, in cases in which the management server 80 has received additional bonus game start information (second notice), in addition to the first bonus game start information (first notice), the gaming machine groups are selected from among the gaming machines 1a through 1h. For example, an arrangement may be made in which the gaming machines around a gaming machine where a bonus game has been triggered are selected as the corresponding gaming machine group. This increases the gaming motivation of the players at the gaming machines around the gaming machine where a bonus game has been triggered.

A description has been made in the present embodiment regarding an arrangement for handling a situation in which two bonus games have been triggered in a predetermined period of time. However, the present invention is not restricted to such an arrangement. Also, an arrangement may be made having a function of handling a situation in which multiple bonus games have been triggered after a player has triggered a first bonus game. In this case, an arrangement may be made in which the succeeding bonus games are executed after the first bonus game ends. In such an arrangement, the bonus games may be executed one after another in order of the point in time at which the players have triggered the bonus games.

### Fourth Embodiment

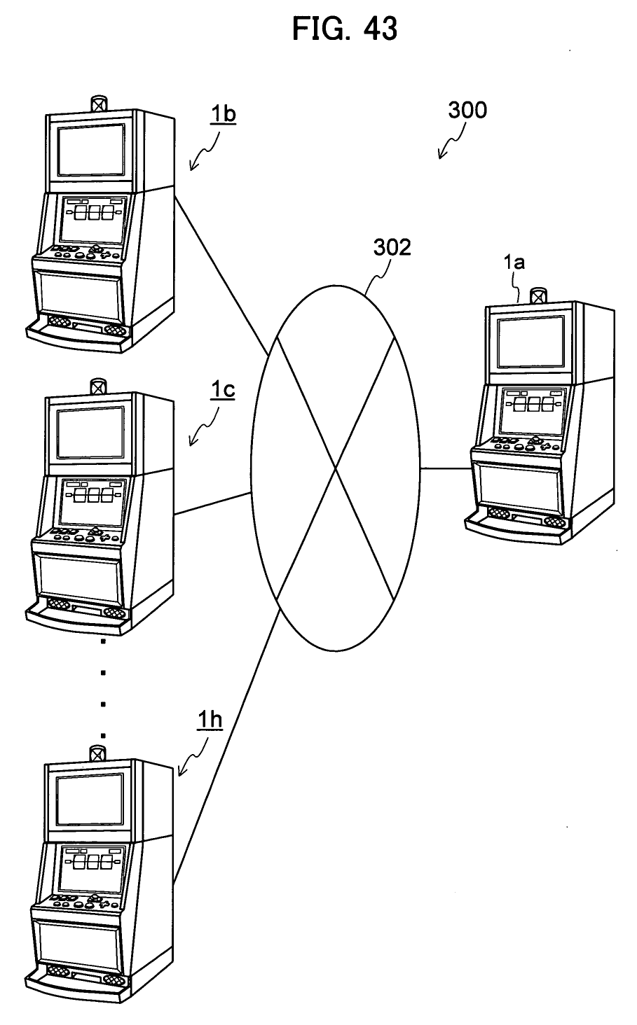

Next, a description will be made regarding a fourth embodiment with reference to FIG. 43. Note that description will be made regarding only components which differ from those in the second embodiment. Accordingly, in general, the same components as those in the second embodiment will be omitted. FIG. 43 shows a schematic configuration of a gaming machine network system 300 in which the gaming machines 1a through 1h are connected with one another via a network 302. In the system 300, there is no master/slave relation among the gaming machines 1a through 1h, and the gaming machines 1a through 1h have the same function, unlike the second embodiment. That is to say, each of the gaming machines 1a through 1h, has a function of providing a bonus game. Furthermore, each of the gaming machines 1a through 1h, has a configuration which allows the player to participate in a bonus game which has been initiated by one of other players at another gaming machine. Furthermore, each of the gaming machines 1a through 1h, has a function of being a management server described in the first embodiment. Furthermore, the present embodiment may have a function of selecting predetermined gaming machines (e.g., gaming machines 1a through 1c) for handling a situation in which multiple players have triggered bonus games, in the same way as with the third embodiment.

1-18. (canceled)

19. A gaming system comprising:
a plurality of gaming machines each of which include
special game initiation device for initiating a special game in which the player is given an advantage in comparison with a basic game, and
game value providing device for providing a player with a game value; and
a management server which is connected to said plurality of gaming machines via communication device, and which has a function of centrally managing the amount of the game value paid out from each of said gaming machines,
wherein each of said plurality of gaming machines includes
special game information transmitting device for transmitting special game information to said management server, which notifies said management server that a special game has been initiated by said special game initiation device, and
special game participation information transmitting device for transmitting special game participation information to said management server, which notifies said management server of the participation in said special game,
and wherein said management server includes
special game information receiving device for receiving said special game information transmitted by said special game information transmitting device,
special game initiation information transmitting device for transmitting special game initiation information to the gaming machines other than the gaming machine where said special game has been initiated, which notifies the gaming machines of the initiation of the special game,
special game participation information receiving device for receiving said special game participation information from said plurality of gaming machines, and
game value providing command transmitting device for transmitting a command to said gaming machines, which instructs said game value providing device to provide the players with game values corresponding to the results of said special game.

20. A gaming system according to claim 19, wherein said game value providing command transmitting device of said management server transmits a command, which instructs said game value providing device to provide a game value, to each of said plurality of gaming machines, such that there is difference in said game value, provided by said game value providing device, between the gaming machine that has transmitted the special game information via said special game information transmitting device and the other gaming machines that have not transmitted said special game information.

21. A gaming system according to claim 19, wherein said game value providing command transmitting device of said management server transmits a command, which instructs said game value providing device to provide a game value, to each of said plurality of gaming machines, such that said game value providing device provides game values corresponding to the results of said special game.

22. A management server which is connected to plurality of gaming machines, each of which includes special game initiation device for initiating a special game in which a player is given an advantage in comparison with a basic game, and game value providing device for providing players with game values, via communication device, and which has a function of centrally managing the amount of the game value paid out from each of said gaming machines, said management server comprising:
special game information receiving device for receiving special game information from at least one of said plurality of gaming machines, which notifies said management server of the initiation of said special game;
special game initiation information transmitting device for transmitting special game initiation information to the gaming machines other than the gaming machine that has transmitted said special game information, which notifies the gaming machines of the initiation of said special game;
special game participation information receiving device for receiving special game participation information from said plurality of gaming machines, which notifies said management server of the participation in said special game; and
game value providing command transmitting device for transmitting a command to said gaming machines, which instructs said game value providing device to provide the players with game values corresponding to the results of said special game.

23. A management server according to claim 22, wherein said game value providing command transmitting device transmits a command, which instructs said game value providing device to provide a game value, to each of said plurality of gaming machines, such that there is difference in said game value, provided by said game value providing device, between at least one gaming machine of said plurality of gaming machines and the other gaming machines.

24. A management server according to claim 22, wherein said game value providing command transmitting device transmits a command, which instructs said game value providing device to provide a game value, to each of said plurality of gaming machines, such that said game value providing device provide game values corresponding to the results of said special game.

25. A gaming machine that includes special game initiation device for initiating a special game in which the player is given an advantage in comparison with a basic game, and game value providing device for providing a player with a game value, and which is connected to a management server via communication device for centrally managing the amount of the game value paid out by said game value providing device, said gaming machine comprising:
special game initiation information receiving device for receiving special game initiation information from said management server, which notifies said gaming machine of the initiation of a special game;
special game participation transmitting device for transmitting special game participation information to said management server, which notifies said management server of the participation in said special game; and
game value providing command receiving device for receiving a command from said management server, which instructs said game value providing device to provide a game value.

26. A gaming machine according to claim 25, further comprising special game information transmitting device for transmitting special game information to said management server through said communication device, which notifies said management server of the initiation of said special game,
wherein said game value providing command receiving device receive a command from said management server, which instructs said game value providing device to provide game values that differ in amount between cases in which the special game information has been transmitted through said special game information transmitting device and cases in which the special game information has not been transmitted through said special game information transmitting device.

27. A gaming machine according to claim 25, wherein said game value providing command receiving device receive a command from said management server, which instructs said game value providing device to provide a game value corresponding to the results of said special game.

28. A gaming system comprising:
a first gaming machine which provides a basic game and a special game in which a player is given an advantage in comparison with the basic game;
a management server having a function of transmission/reception of information to and from said first gaming machine; and
a second gaming machine having a function of transmission/reception of information to and from said management server,
wherein, in cases in which said special game is triggered in said basic game in said first gaming machine, said first gaming machine transmits special game information to said management server, which notifies said management server of the initiation of said special game,
and wherein, upon reception of said special game information, said management server creates special game participation selection information based upon said special game information, and transmit said special game participation selection information to said second gaming machine,
and wherein said second gaming machine provides the player at said second gaming machine with said special game participation selection information,
and wherein, upon the player at said second gaming machine inputting participation selection input data, said second gaming machine creates special game participation information based upon said participation selection input data, and transmits said special game participation information to said management server,
and wherein said management server transmits a start command for said special game to said first gaming machine and said second gaming machine according to said special game participation information,
and wherein said management server transmits progress information to said first and second gaming machines during the progress of said special game while receiving input data from the players at said first gaming machine and/or the player at said second gaming machine, in order to advance said special game,
and wherein said management server creates command information based upon the results of said special game and transmits said command information to said first and second gaming machines, which instructs said first gaming machine and/or said second gaming machine to provide each player with a corresponding game value.

29. A gaming system according to claim 28, further comprising a third gaming machine having a function of transmission/reception of information to and from said management server,
wherein, in cases in which said management server has not received said special game participation information from said third gaming machine in a predetermined period of time after said management server has transmitted said special game participation selection information to said third gaming machine, said management server does not transmit information for said special game to said third gaming machine.

30. A gaming system according to claim 28 or claim 29, wherein said management server transmits said command information to said first gaming machine and/or said second gaming machine, so as to provide the players at said first gaming machine and said second gaming machine with different game values.

31. A management server having a function of transmission/reception of information to and from a first gaming machine and a second gaming machine each of which provides a basic game and a special game in which a player is given an advantage in comparison with the basic game,
wherein said management server receives special game information transmitted from said first gaming machine, which notifies said management server of the initiation of said special game, creates special game participation selection information based upon said special game information, and transmits said special game participation selection information to said second gaming machine,
and wherein, in cases in which said second gaming machine has created special game participation information based upon participation selection input data input by the player, said management server receives said special game participation information from said second gaming machine, and transmits a start command for said special game to each of said first and second gaming machine,
and wherein said management server transmits progress information to said first and second gaming machines during the progress of said special game while receiving input data from the player at said first gaming machine and/or the player at said second gaming machine, in order to advance said special game,
and wherein said management server creates command information based upon the results of said special game and transmits said command information to said first and second gaming machines, which instructs said first gaming machine and/or said second gaming machine to provide each player with a corresponding game value.

32. A management server according to claim 31, having a function of transmission/reception of information to and from a third gaming machine,
wherein, in cases in which said management server has not received said special game participation information from said third gaming machine in a predetermined period of time after said management server has transmitted said special game participation selection information to said third gaming machine, said management server does not transmit information for said special game to said third gaming machine.

33. A management server according to claim 31, wherein said management server transmits said command information to said first gaming machine and/or said second gaming machine, so as to provide different game values to the players at said first gaming machine and said second gaming machine.

34. A first gaming machine which comprises a display for displaying information regarding a game, a receiver that allows a player to input data for starting a game, and a control device for controlling the progress of the game, and which provides a basic game and a special game in which the player is given an advantage in comparison with the basic game,
wherein said first gaming machine has a function of transmission/reception of information to and from a second gaming machine,
wherein, in cases in which the game stage being executed by said first gaming machine has switched from said basic game stage to said special-game stage, said first gaming machine creates special game participation selection information based upon special game information which is a notification that said special game is to be initiated, and transmits said special game participation selection information to said second gaming machine,
and wherein said second gaming machine provides said special game participation selection information to the player at said second gaming machine, creates special game participation information based upon participation selection input data input by the player at said second gaming machine, and transmits said special game participation information to said first gaming machine,
and wherein said first gaming machine creates a start command for said special game based upon said special game participation information, which instructs said first gaming machine to start said special game, and which is transmitted to said second gaming machine,
and wherein said first gaming machine transmits progress information to said second gaming machine during the progress of said special game while receiving the input data input by the players at said first gaming machine and/or said second gaming machine directly or through said second gaming machine, in order to advance said special game,
and wherein said first gaming machine creates command information based upon the results of said special game and transmits said command information to second gaming machine, which instructs said first gaming machine and/or said second gaming machine to provide each player with a corresponding game value.

35. A second gaming machine which comprises a display for displaying information regarding a game, a receiver that allows a player to input data, and a control device for controlling the progress of the game, and which has a function of providing a special game in which the player is given an advantage in comparison with a basic game,
wherein said second gaming machine has a function of transmission/reception of information to and from a first gaming machine having a function of transmitting special game participation selection information based upon special game information that notifies said second gaming machine of the initiation of said special game,
and wherein said second gaming machine provides said special game participation selection information to the player at said second gaming machine, creates special game participation information based upon participation selection input data input by the player at said second gaming machine, and transmits said special game participation information to said first gaming machine,
and wherein said second gaming machine receives a start command for said special game transmitted from said first gaming machine,
and wherein said second gaming machine receives the progress information from said first gaming machine during the progress of said special game while receiving the input data input by the player at said second gaming machine, in order to advance said special game,
and wherein said second gaming machine receives command information corresponding to the results of said special game from said first gaming machine, which instructs said second gaming machine to provide a corresponding game value to the player at said second gaming machine.

36. A network gaming machine system comprising:
a first gaming machine which comprises a display for displaying information regarding a game, a receiver that allows a player to input data for starting a game, and a control device for controlling the progress of the game, and which provides a basic game and a special game in which the player is given an advantage in comparison with the basic game;
a network to which said first gaming machine is connected; and
a second gaming machine which is connected to said network, and can be connected to said first gaming machine via said network,
wherein said second gaming machine comprises a display for displaying the information regarding the game, a receiver that allows a player to input data for starting a game, and a control device for controlling the progress of the game, and which has a function of providing a basic game and a special game in which the player is given an advantage in comparison with the basic game,
wherein, in cases in which the game stage being executed by said first gaming machine has switched from said basic game stage to said special-game stage, said first gaming machine creates special game participation selection information based upon special game information, which is a notice that said special game is to be initiated, and transmits said special game participation selection information to said second gaming machine,
and wherein said second gaming machine provides said special game participation selection information to the player at said second gaming machine, creates special game participation information based upon participation selection input data input by the player at said second gaming machine, and transmits said special game participation information to said first gaming machine,
and wherein said first gaming machine creates a start command for said special game based upon said special game participation information, which instructs said first gaming machine to start said special game, and which is transmitted to said second gaming machine,
and wherein said first gaming machine transmits progress information to said second gaming machine during the progress of said special game while receiving the input data input by the players at said first gaming machine and/or said second gaming machine directly or through said second gaming machine, in order to advance said special game,
and wherein said first gaming machine creates command information based upon the results of said special game and transmits said command information to second gaming machine, which instructs said first gaming machine and/or said second gaming machine to provide each player with a corresponding game value.
